(19) United States
(12) Patent Application Publication
(10) Pub. No.: US 2023/0171763 A1
(43) Pub. Date: Jun. 1, 2023

(54) METHOD AND DEVICE FOR SIMULTANEOUS TRANSMISSION TO MULTIPLE TRANSMISSION AND RECEPTION POINTS (TRPs)

(71) Applicant: Telefonaktiebolaget LM Ericsson (publ), Stockholm (SE)

(72) Inventors: Shiwei Gao, Nepean (CA); Mattias Frenne, Uppsala (SE); Siva Muruganathan, Stittsville (CA); Jianwei Zhang, Solna (SE)

(21) Appl. No.: 17/919,313

(22) PCT Filed: Apr. 16, 2021
(86) PCT No.: PCT/IB2021/053177

§ 371 Date: Oct. 17, 2022

Related U.S. Application Data
(60) Provisional application No. 63/011,707, filed on Apr. 17, 2020.

(51) Int. Cl. H04W 72/1268; H04W 72/23; H04L 5/00; H04W 52/24; H04W 52/08

(52) U.S. Cl. CPC H04W 72/1268; H04W 72/23; H04L 5/0051; H04W 52/242; H04W 52/08

(57) ABSTRACT

Systems and methods are disclosed herein that relate to multi-Transmission/Reception Point (TRP) uplink transmission in a cellular communications system. In one embodiment, a method performed by a wireless communication device comprises receiving, from a network node, a configuration of two Sounding Reference Signal (SRS) resource sets, a first and second SRS resource sets, each comprising one or more SRS resources. The method further comprises receiving, from the network node, downlink control information (DCI) that schedules a physical uplink channel transmission comprising a first part associated to a first SRS resource in the first SRS resource set and a second part associated to a second SRS resource in the second SRS resource set, wherein the first and second SRS resources are indicated in the DCI. The method further comprises transmitting the physical uplink channel transmission in accordance with the DCI.

### RELATED APPLICATIONS

This application claims the benefit of provisional patent application Ser. No. 63/011,707, filed Apr. 17, 2020, the disclosure of which is hereby incorporated herein by reference in its entirety.

### TECHNICAL FIELD

The present disclosure relates to uplink transmission to multiple Transmission and Reception Points (TRPs) in a cellular communications system.

### BACKGROUND

The next generation mobile wireless communication system (5G), or new radio (NR), will support a diverse set of use cases and a diverse set of deployment scenarios. The later includes deployment at both low frequencies (i.e., frequencies below 6 Gigahertz (GHz)) and very high frequencies (i.e., frequencies up to 10's of GHz).

1 NR Frame Structure and Resource Grid

NR uses Cyclic Prefix Orthogonal Frequency Division Multiplexing (CP-OFDM) in both downlink (DL) (i.e., from a network node, gNB, or base station, to a user equipment or UE) and uplink (UL) (i.e., from UE to gNB). Discrete Fourier Transform (DFT) spread Orthogonal Frequency Division Multiplexing (OFDM) is also supported in the uplink. In the time domain, NR downlink and uplink are organized into equally sized subframes of 1 millisecond (ms) each. A subframe is further divided into multiple slots of equal duration. The slot length depends on subcarrier spacing. For subcarrier spacing of Δf=15 kilohertz (kHz), there is only one slot per subframe, and each slot consists of fourteen OFDM symbols.

Data scheduling in NR is typically in slot basis. An example is shown in FIG. 1 with a 14-symbol slot for 15 kHz subcarrier spacing, where the first two symbols contain Physical Downlink Control Channel (PDCCH) and the rest contains physical shared data channel, either Physical Downlink Shared Channel (PDSCH) or Physical Uplink Shared Channel (PUSCH).

Different subcarrier spacing values are supported in NR. The supported subcarrier spacing values (also referred to as different numerologies) are given by Δf=(15×2^{μ}) kHz where μ∈{0,1,2,3,4}. Δf=15 kHz is the basic subcarrier spacing. The slot durations at different subcarrier spacings is given by 1/2^{μ} ms.

In the frequency domain, a system bandwidth is divided into resource blocks (RBs), each corresponds to twelve contiguous subcarriers. The RBs are numbered starting with 0 from one end of the system bandwidth. The basic NR physical time-frequency resource grid is illustrated in FIG. 2, where only one RB within a 14-symbol slot is shown. One OFDM subcarrier during one OFDM symbol interval forms one resource element (RE).

In NR Release 15, UL data transmission can be dynamically scheduled by an UL grant contained in Downlink Control Information (DCI) carried by a Physical Downlink Control Channel (PDCCH). A UE first decodes the uplink grant and then transmits data over a Physical Uplink Share Channel (PUSCH) based the decoded control information in the UL grant such as modulation order, coding rate, uplink resource allocation, etc. Three DCI formats are supported in NR Release 16, i.e., DCI format 0_0, DCI format 0_1, and DCI format 0_2. Each DCI contains a number of bit fields each conveys certain information, including:
Bandwidth Indicator
Time Domain Resource Allocation (TDRA)
Frequency Domain Resource Allocation (FDRA)
Modulation and Coding Scheme (MCS)
Hybrid Automatic Repeat Request (HARQ) process number
New Data Indicator
Redundancy Version (RV)
Sounding Resource Indicator (SRI)
Precoding information and number of layers
Antenna ports
Sounding Reference Signal (SRS) request and etc.
Channel State Information (CSI) request
Phase Tracking Reference Signal (PTRS)—Demodulation Reference Signal (DMRS) (i.e., PTRS-DMRS) association
Transmit Power Control (TPC) command for scheduled PUSCH

In addition to dynamic scheduling of PUSCH, there is also a possibility to configure semi-persistent transmission of PUSCH using configured grants (CGs). There are two types of CG based PUSCH defined in NR Release 15, which are referred to as CG type 1 and CG type 2. In CG type 1, a periodicity of PUSCH transmission as well as the start and stop of such transmission are configured by Radio Resource Control (RRC). In CG type 2, a periodicity of PUSCH transmission is configured by RRC and then the start and stop of such transmission is controlled by DCI, i.e., with a PDCCH.

In NR, it is possible to schedule a PUSCH with time repetition via a RRC parameter pusch-AggregationFactor for dynamically scheduled PUSCH and repK for PUSCH with UL configured grant. In this case, the PUSCH is scheduled but transmitted in multiple adjacent slots up until the number of repetitions as determined by the configured RRC parameter have been transmitted.

In the case of PUSCH with UL configured grant, the RV sequence to be used is configured by the repK-RV field when repetitions are used. If repetitions are not used for PUSCH with UL configured grant, then the repK-RV field is absent.

In NR Release 15, two mapping types applicable to PUSCH transmission are supported. These two mapping types are referred to as Type A and Type B. Type A PUSCH transmissions are usually referred to as slot-based transmissions, while Type B PUSCH transmissions may be referred to as non-slot-based transmissions or mini-slot-based transmissions. Mini-slot transmissions can be dynamically scheduled and for NR Release 15:
can be of length 7, 4, or 2 symbols for downlink, while it can be of any length for uplink, and
can start and end in any symbol within a slot.
   Note that mini-slot transmissions in NR Release 15 may not cross the slot-border.

2 PUSCH Transmission Schemes

In NR, there are two transmission schemes specified for PUSCH.

2.1 Codebook Based PUSCH

Codebook based PUSCH is enabled if higher layer parameter txConfig=codebook. For dynamically scheduled PUSCH and configured grant PUSCH type 2, the codebook based PUSCH transmission scheme can be summarized as follows:
The UE transmits SRS in one or two configured SRS resources. The one or two SRS resources are configured in an SRS resource set with a higher layer parameter usage set to ‘CodeBook’. Note that only a single SRS resource set can be configured with usage set to “Codebook”.
The NR base station (gNB) determines a preferred precoder (i.e., Transmit Precoding Matrix Indicator (TPMI)) from a codebook and the associated number of layers corresponding to SRS received from one of the one or two SRS resources.
The gNB indicates the selected SRS resource via a 1-bit ‘SRS resource indicator’ (SRI) field in a DCI scheduling the PUSCH if two SRS resources are configured in the SRS resource set. The ‘SRS resource indicator’ field is not indicated in DCI if only one SRS resource is configured in the SRS resource set.
The gNB also indicates the preferred TPMI and the associated number of layers corresponding to the indicated SRS resource (in case two SRS resources are used) or the configured SRS resource (in case one SRS resource is used). TPMI and the number of layers is indicated by the ‘Precoding information and number of layers’ field in DCI formats 0_1 and 0_2.
The UE performs PUSCH transmission using the TPMI and the number of layers indicated. If one SRS resource is configured in the SRS resource set associated with the higher layer parameter usage of value ‘CodeBook’, then the PUSCH DMRS is spatially related to the most recent SRS transmission in this SRS resource. If two SRS resources are configured in the SRS resource set associated with the higher layer parameter usage of value ‘CodeBook’, then the PUSCH DMRS is spatially related to the most recent SRS transmission in the SRS resource indicated by the ‘SRS resource indicator’ field.
One (or more) DMRS port associated to one (or more) layer is indicated in an “Antenna ports” field in the DCI together with a number of CDM groups without being multiplexed with PUSCH data.

2.2 Non-Codebook Based PUSCH

Non-Codebook based UL transmission is also supported in NR, enabling reciprocity-based UL transmission in which SRS precoding is derived at a UE based on a configured DL Channel State Information Reference Signal (CSI-RS). By assigning a DL CSI-RS to the UE, it can measure and deduce suitable precoder weights for SRS transmission, resulting one or more (virtual) SRS ports, each corresponding to a spatial layer. A UE can be configured with up to four SRS resources, each with a single (virtual) SRS port, in an SRS resource set. A UE can transmit SRS in the up to four SRS resources, and the gNB measures the UL channel based on the received SRS and determines the preferred SRS resource(s) (or SRS port(s)). Subsequently, the gNB indicates the selected SRS resources via a SRS resource indicator (SRI), where the selected SRS resources are jointly encoded using

$$⌈ {log}_{2} ( {\sum }_{k = 1}^{min \{ {L}_{max} , {N}_{SRS} \}} ( \begin{matrix}{N}_{SRS} \\ k\end{matrix} ) ) ⌉$$

bits, where N_{SRS} indicates the number of configured SRS resources, and Lₘₐₓ is the maximum number of supported layers for PUSCH. Note that only a single SRS resource set can be configured with “non-codebook”.

3 Spatial Relation Definition

Spatial relation is used in NR to refer to a relationship between an UL signal or channel such as PUCCH, PUSCH, and SRS and another Reference Signal (RS), which can be either a DL RS (e.g., CSI-RS, SSB (synchronization signal block)) or an UL RS (e.g., SRS). This is also defined from a UE perspective.

If an UL signal or channel is spatially related to a DL RS, it means that the UE should transmit the UL signal or channel in the opposite (reciprocal) direction from which it received the DL RS previously. More precisely, the UE should apply the “same” Transmit (TX) spatial filtering configuration for the transmission of the UL signal or channel as the Receive (Rx) spatial filtering configuration it used to receive the spatially related DL RS previously. Here, the terminology ‘spatial filtering configuration’ may refer to the antenna weights that are applied at either the transmitter or the receiver for data/control transmission/reception. The DL RS is also referred as the spatial filter reference signal.

On the other hand, if a first UL signal or channel is spatially related to a second UL RS, then the UE should apply the same Tx spatial filtering configuration for the transmission for the first UL signal or channel as the Tx spatial filtering configuration it used to transmit the second UL RS previously.

For the SRS resource set for codebook based PUSCH scheme, it can contain up to two SRS resources. Each of the SRS resources can have 1, 2, or 4 SRS ports. Each SRS resource can be spatially related to another RS (e.g., a SSB, a Non-Zero Power (NZP) CSI-RS, or another SRS) through a spatial relation configuration. The spatial relation of a PUSCH is given by the spatial transmission properties associated with the associated SRS resource.

For the SRS resource set for non-codebook based PUSCH scheme, it can contain up to four SRS resources each with a single SRS port. Each SRS resource set is associated with a CSI-RS over which a UE derives SRS precoders for each SRS port. The spatial relation of a PUSCH is given by the CSI-RS configured for the SRS resource set.

4 TCI States for Uplink

Several signals can be transmitted from different antenna ports of a same base station antenna. These signals can have the same large-scale properties, for instance in terms of Doppler shift/spread, average delay spread, or average delay, when measured at the receiver. These antenna ports are then said to be quasi co-located (QCL).

The network can then signal to the UE that two antenna ports are QCL. If the UE knows that two antenna ports are QCL with respect to a certain parameter (e.g., Doppler spread), the UE can estimate that parameter based on a reference signal transmitted one of the antenna ports and use that estimate when receiving another reference signal or physical channel the other antenna port. Typically, the first antenna port is represented by a measurement reference signal such as CSI-RS (known as source RS) and the second antenna port is a demodulation reference signal (DMRS) (known as target RS) for PDSCH or PDCCH reception.

In NR, four types of QCL relations between a transmitted source RS and transmitted target RS were defined:
Type A: {Doppler shift, Doppler spread, average delay, delay spread}
Type B: {Doppler shift, Doppler spread}
Type C: {average delay, Doppler shift}
Type D: {Spatial Rx parameter}
   QCL type D was introduced to facilitate beam management with analog beamforming and is known as spatial QCL. There is currently no strict definition of spatial QCL, but the understanding is that if two transmitted antenna ports are spatially QCL, the UE can use the same Rx beam to receive them. This is helpful for a UE that uses analog beamforming to receive signals, since the UE needs to adjust its RX beam in some direction prior to receiving a certain signal. If the UE knows that the signal is spatially QCL with some other signal it has received earlier, then it can safely use the same RX beam to receive also this signal. Note that for beam management, the discussion mostly revolves around QCL Type D, but it is also necessary to convey a Type A QCL relation for the RSs to the UE, so that it can estimate all the relevant large-scale parameters.

Information about what assumptions can be made regarding QCL is signaled to the UE from the network through Transmission Configuration Indicator (TCI) states. Each TCI state contains QCL information, i.e., one or two source DL RSs, each source RS associated with a QCL type. For example, a TCI state contains a pair of reference signals, each associated with a QCL type, e.g. two different CSI-RSs {CSI-RS1, CSI-RS2} is configured in the TCI state as {qcl-Type1,qcl-Type2}={Type A, Type D}. It means the UE can derive Doppler shift, Doppler spread, average delay, delay spread from CSI-RS1 and Spatial Rx parameter (i.e., the RX beam to use) from CSI-RS2. TCI states are used in NR for downlink channels and signals.

In NR Release 15, the handling of spatial transmission properties is different for PUSCH, PUCCH, and SRS. For PUCCH, the spatial relation information is configured in information element PUCCH-SpatialRelationInfo, and the spatial relation information for SRS is configured as part of SRS resource configuration. The spatial transmission properties for PUSCH are given by the spatial transmission properties of the associated SRS resource(s) in the SRS resource set configured with ‘Codebook’ or ‘non-Codebook’. Such a handling of the spatial transmission properties is cumbersome and inflexible when it comes to uplink multi-panel transmission in NR.

There were proposals to also use a TCI states framework to indicate the spatial properties for all the UL channels or signals (i.e., PUSCH, PUCCH, and SRS) in uplink. The idea was to use uplink TCI state to indicate one out of multiple uplink panels and the corresponding transmission beams (i.e., transmission properties) at the UE to transmit UL PUSCH/PUCCH/SRS when the UE is equipped with multiple panels. Each TCI state can contain one reference signal for spatial relation indication, one RS for pathloss estimation, and possibly a set of power control parameters.

In general, a list of uplink TCI states can be configured by higher layers (i.e., RRC) for a UE. A subset may be activated by a Medium Access Control (MAC) Control Element (CE). One of the activated TCI states can be indicated in DCI for PUSCH.

5 PUSCH Power Control

For each SRI, a pathloss RS and a set of power control parameters (e.g., fractional power control coefficient, P0, closed-loop index) are preconfigured and signaled to a UE. PUSCH open loop transmit power is then derived based the SRI indicated in the DCI and the associated pre-configured pathloss RS and the set of power control parameters.

Closed-loop power control is done by sending a transmit power control command (TPC) in a 2-bit “TPC command for scheduled PUSCH” field in a DCI scheduling the PUSCH. The mapping between a TPC value and power correction is shown in Table 1, where the “Accumulated [dB]” column is used if the UE is configured with accumulation mode and the “Absolute” column is used otherwise.

TABLE 1
Mapping of TPC Command Field in a DCI format scheduling
a PUSCH transmission, or in DCI format 2_2 with
CRC scrambled by TPC-PUSCH-RNTI, or in DCI format
2_3, to absolute and accumulated values or values

| TPC Command Field | Accumulated [dB] | Absolute [dB] |
|---|---|---|
| 0 | −1 | −4 |
| 1 | 0 | −1 |
| 2 | 1 | 1 |
| 3 | 3 | 4 |

### SUMMARY

Systems and methods are disclosed herein that relate to multi-Transmission/Reception Point (TRP) uplink transmission in a cellular communications system. In one embodiment, a method performed by a wireless communication device comprises receiving, from a network node, a configuration of two Sounding Reference Signal (SRS) resource sets, a first and second SRS resource sets, each comprising one or more SRS resources. The method further comprises receiving, from the network node, downlink control information (DCI) that schedules a physical uplink channel transmission comprising a first part associated to a first SRS resource in the first SRS resource set and a second part associated to a second SRS resource in the second SRS resource set, wherein the first and second SRS resources are indicated in the DCI. The method further comprises transmitting the physical uplink channel transmission in accordance with the DCI. In this manner, robust uplink transmission over multiple TRPs can be provided.

In one embodiment, the first and second SRS resources are indicated in a first and a second SRS Resource Indicator (SRI) fields in the DCI, respectively. In one embodiment, the first and second SRI fields are associated with the first and second SRS resource sets, respectively. In one embodiment, a set of possible codepoints for each of the first and second SRI fields in the DCI comprises a codepoint to indicate that a corresponding SRS resource is not selected.

In one embodiment, the method further comprises receiving a configuration of first and second sets of power control parameters associated with the first and second SRS resources, respectively, wherein each of the first and second sets of power control parameters comprise a pathloss reference signal, a fractional power control factor, a target receive power, a closed-loop power control index, or any combination thereof. In one embodiment, the first and second parts of the physical uplink channel transmission are transmitted with a first and second transmit powers, respectively, wherein the first and second transmit powers are calculated based on the first and second sets of power control parameters, respectively.

In one embodiment, the physical uplink channel transmission is a physical uplink shared channel (PUSCH) transmission.

In one embodiment, the DCI further indicates a first and second Transmit Power Control (TPC) commands for the first and second parts of the physical uplink channel transmission, respectively.

In one embodiment, the first and second parts of the physical uplink channel transmission are different parts of a single PUSCH transmitted in different frequency domain resources.

In one embodiment, the first and second parts of the physical uplink channel transmission are a first and second PUSCHs carrying different redundancy versions of a same Transport Block (TB) and transmitted in different frequency domain resources.

In one embodiment, the first and second parts of the physical uplink channel transmission are a first and second layers of a single PUSCH and are transmitted in a same time and frequency domain resource.

In one embodiment, the first and second SRS resources indicated in the DCI may be replaced with a first and second uplink Transmission Configuration Indicator (TCI) states, wherein each of the first and second TCI states comprises a reference signal index for spatial relation indication, a pathloss reference signal index, a set of power control parameters, or any combination thereof.

Corresponding embodiments of a wireless communication device are also disclosed. In one embodiment, a wireless communication device is adapted to receive, from a network node, a configuration of two SRS resource sets each comprising one or more SRS resources. The wireless communication device is further adapted to receive, from the network node, DCI that schedules a physical uplink channel transmission comprising a first part associated to a first SRS resource in the first SRS resource set and a second part associated to a second SRS resource in the second SRS resource set, wherein the first and second SRS resources are indicated in the DCI. The wireless communication device is further configured to transmit the physical uplink channel transmission in accordance with the DCI.

In one embodiment, a wireless communication device comprises one or more transmitters, one or more receivers, and processing circuitry associated with the one or more transmitters and the one or more receivers. The processing circuitry is configured to cause the wireless communication device to receive, from a network node, a configuration of two SRS resource sets each comprising one or more SRS resources. The processing circuitry is further configured to cause the wireless communication device to receive, from the network node, DCI that schedules a physical uplink channel transmission comprising a first part associated to a first SRS resource in the first SRS resource set and a second part associated to a second SRS resource in the second SRS resource set, wherein the first and second SRS resources are indicated in the DCI. The processing circuitry is further configured to cause the wireless communication device to transmit the physical uplink channel transmission in accordance with the DCI.

Embodiments of a method performed by a network node are also disclosed herein. In one embodiment, a method performed by a network node comprises sending, to a wireless communication device, a configuration of two SRS resource sets, a first and second SRS resource sets, each comprising one or more SRS resources. The method further comprises sending, to the wireless communication device, DCI that schedules a physical uplink channel transmission comprising a first part associated to a first SRS resource in the first SRS resource set and a second part associated to a second SRS resource in the second SRS resource set, wherein the first and second SRS resources are indicated in the DCI.

Corresponding embodiments of a network node are also disclosed. In one embodiment, a network node is adapted to send, to a wireless communication device, a configuration of two SRS resource sets, a first and second SRS resource sets, each comprising one or more SRS resources. The network node is further adapted to send, to the wireless communication device, DCI that schedules a physical uplink channel transmission comprising a first part associated to a first SRS resource in the first SRS resource set and a second part associated to a second SRS resource in the second SRS resource set, wherein the first and second SRS resources are indicated in the DCI.

In one embodiment, a network node comprises processing circuitry configured to cause the network node to send, to a wireless communication device, a configuration of two SRS resource sets, a first and second SRS resource sets, each comprising one or more SRS resources. The processing circuitry is further configured to cause the network node to send, to the wireless communication device, DCI that schedules a physical uplink channel transmission comprising a first part associated to a first SRS resource in the first SRS resource set and a second part associated to a second SRS resource in the second SRS resource set, wherein the first and second SRS resources are indicated in the DCI.

In one embodiment, a method performed by a wireless communication device for uplink transmission to a cellular communications network comprises transmitting one or more PUSCHs using two or more Transmission Configuration Indicator (TCI) states on either: (a) a same time and frequency domain resource or (b) a same time domain resource but different frequency domain resources. The two or more TCI states are associated with two or more different reference signals, respectively.

In one embodiment, the method further comprises receiving, from a network node, downlink control information that schedules transmission of the one or more PUSCHs, wherein the downlink control information indicates the two or more TCI states.

In one embodiment, the two or more reference signals are two or more downlink reference signals each associated with a respective one of the two or more TCI states. In one embodiment, each of the two or more downlink reference signals is a Synchronization Signal Block (SSB) or a Non-Zero Power (NZP) Channel State Information Reference Signal (CSI-RS).

In one embodiment, the two or more reference signals are two or more SRS resources, each configured with a respective spatial relation. In one embodiment, the downlink control information comprises one or more SRIs that indicate the two or more SRS resources. In one embodiment, each of the two or more SRS resources is associated with a respective reference signal through a spatial relation configuration. In one embodiment, the respective reference signal is a SSB, a NZP CSI-RS, or another SRS.

In one embodiment, the two or more SRS resources are associated with two or more respective reference signals, and the two or more respective reference signals are associated with two or more respective cell identities. In one embodiment, the two or more respective reference signals are two or more respective SSBs or two or more respective NZP CSI-RSs. In one embodiment, the two or more respective reference signals are associated with the two or more respective cell identities via a field in a TCI state configuration.

In one embodiment, the two or more respective reference signals are two or more respective SSBs, and the two or more reference signals are associated with the two or more respective cell identities via SSB configuration.

In one embodiment, transmitting the one or more PUSCHs comprises transmitting a first part of the one or more PUSCHs using a first TCI state from among the two or more TCI states and transmitting a second part of the one or more PUSCHs using a second TCI state from among the two or more TCI states. The method further comprises receiving an indication of a pathloss reference signal and a set of power control parameters associated to each of the two or more TCI states via either: one or more SRIs comprised in downlink control information that schedules the one or more PUSCHs, wherein an association between each of the one or more SRIs and one or more pathloss reference signals and one or more sets of power control parameters is signaled to the wireless communication device, or the two or more TCI states, wherein an association between each of the TCI states and one or more pathloss reference signals and one or more sets of power control parameters is signaled to the wireless communication device. In one embodiment, transmitting the first part of the one or more PUSCHs comprises transmitting the first part of the one or more PUSCHs in accordance the set of power control parameters associated to the first TCI state, and transmitting the second part of the one or more PUSCHs comprises transmitting the second part of the one or more PUSCHs in accordance the set of power control parameters associated to the second TCI state.

In one embodiment, the method further comprises receiving, from a network node, an indication to use either a spatial division multiplexing scheme for PUSCH transmission or a frequency division multiplexing scheme for PUSCH transmission. In one embodiment, transmitting the one or more PUSCHs comprises transmitting the one or more PUSCHs on the same time and frequency domain resource if the received indication is an indication to use the spatial division multiplexing scheme for PUSCH transmission or on the same time domain resource but different frequency domain resources if the received indication is an indication to use the frequency division multiplexing scheme for PUSCH transmission.

In one embodiment, the one or more PUSCHs comprise two or more PUSCHs, and each PUSCH of the two or more PUSCHs is scheduled via a separate downlink control information.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrate an example of a typical slot in New Radio (NR);

FIG. 2 illustrates basic NR physical time-frequency resource grid;

FIG. 3 illustrates one example of a cellular communications system in which embodiments of the present disclosure may be implemented;

FIG. 4 shows an example of a User Equipment (UE) transmitting different layers of a Physical Uplink Shared Channel (PUSCH) to two Transmission and Reception Points (TRPs) with Spatial Domain Multiplexing (SDM) in accordance with an embodiment of the present disclosure;

FIG. 5 illustrate an example where a UE transmits two PUSCHs (PUSCH1 and PUSCH2) for a same Transport Block (TB) to two TRPs (TRP1 and TRP2) with SDM in accordance with an embodiment of the present disclosure;

FIG. 6 illustrates an example in which a UE transmits a single PUSCH to two TRPs with part of the frequency-domain resource allocated to each TRP with Frequency Domain Multiplexing (FDM) in accordance with an embodiment of the present disclosure;

FIG. 7 illustrates an example in which a UE transmits two PUSCHs (PUSCH1 and PUSCH2) for a same TB to two TRPs (TRP1 and TRP2) with FDM in accordance with an embodiment of the present disclosure;

FIG. 8 illustrates the operation of a wireless communication device (e.g., a UE) and two TRPs in accordance with at least some of the embodiments described herein;

FIGS. 9A and 9B illustrates the operation of a wireless communication device (e.g., a UE) and two TRPs in accordance with some other embodiments described herein;

FIGS. 10, 11, and 12 are schematic block diagrams of example embodiments of a network node;

FIGS. 13 and 14 are schematic block diagrams of example embodiments of a wireless communication device;

FIG. 15 illustrates an example embodiment of a communication system in which embodiments of the present disclosure may be implemented;

FIG. 16 illustrates example embodiments of the host computer, base station, and UE of FIG. 15; and

FIGS. 17 and 18 are flow charts that illustrate example embodiments of methods implemented in a communication system such as that of FIG. 15.

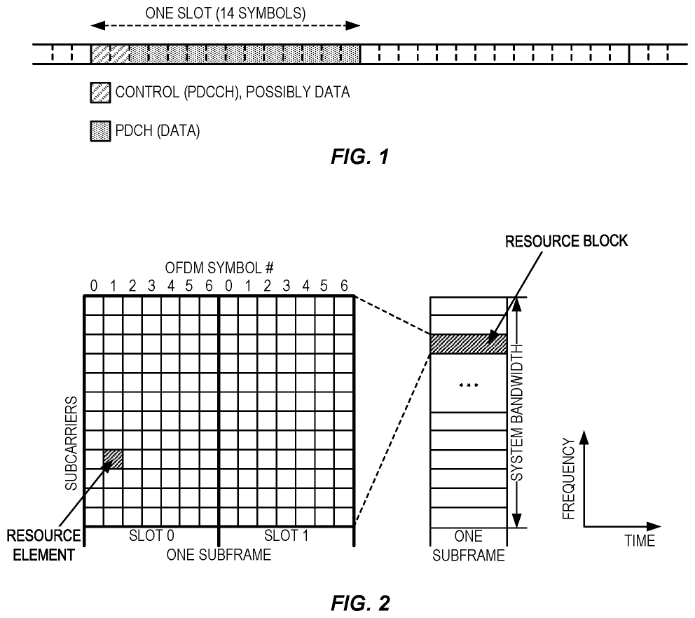

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

In some embodiments, a set Transmission Points (TPs) is a set of geographically co-located transmit antennas (e.g., an antenna array (with one or more antenna elements)) for one cell, part of one cell or one Positioning Reference Signal (PRS)-only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). For dynamically scheduled Physical Uplink Shared Channel (PUSCH) and configured grant PUSCH type 2 (i.e., PUSCH transmission), existing NR Release 15/16 codebook based PUSCH only allows a single Sounding Reference Signal (SRS) resource to be indicated by the gNB in Downlink Control Information (DCI), where this single indicated SRS resource is then used to define the spatial relation for PUSCH. For non-codebook based PUSCH scheme, a single Channel State Information (CSI) Reference Signal (CSI-RS) is associated with the SRS resource set, and a PUSCH's spatial relation is defined by the CSI-RS configured for the corresponding SRS resource set. Therefore, the existing NR Release 15/16 PUSCH is only suitable for single Transmission and Reception Point (TRP) based transmission where the PUSCH transmission is targeted towards a single TRP. It is unsuitable for transmitting a PUSCH towards multiple TRPs. Thus, how to configure a UE for PUSCH transmissions towards multiple TRPs, particularly how to indicate the spatial relations associated to the TRPs, is a problem.

Certain aspects of the present disclosure and their embodiments may provide solutions to the aforementioned or other challenges. Systems and methods are disclosed to support simultaneous uplink (UL) PUSCH transmission towards two or more TRPs by indicating two or more SRS resources in either a single SRS resource set or in different SRS resource sets, including:
transmitting different layers of a PUSCH to different TRPs,
transmitting a PUSCH in different frequency resources to different TRPs, and/or
transmitting two PUSCHs in different frequency resources to different TRPs.

Systems and methods for PUSCH power control per TRP and signaling enhancement in DCI are also disclosed herein.

In one embodiment, a method performed by a UE comprises transmitting one or more PUSCHs to two or more TRPs, each associated with a reference signal (RS), simultaneously in either a same time and frequency domain resource (e.g., using a Spatial Division Multiplexing (SDM) scheme) or a same time domain resource but different frequency domain resources (e.g., using Frequency Division Multiplexing (FDM) scheme).

In one embodiment, the one or more PUSCHs are scheduled by a single DCI.

In one embodiment, two or more RSs are indicated in the DCI. In one embodiment, the two or more RSs are two or more SRS resources each configured with a spatial relation, or two or more downlink (DL) RSs each associated with a Transmission Configuration Indicator (TCI) state. In one embodiment, the indication of two or more SRS resources is via one or more SRS resource indicators (SRIs).

In one embodiment, the two or more RSs indicated in the DCI are two or more SRS resources, and each of the two or more SRS resources is associated with a reference signal such as, e.g., a Synchronization Signal Block (SSB), a Non-Zero Power (NZP) CSI-RS, or another SRS through a spatial relation configuration. In one embodiment, each SSB or NZP CSI-RS is associated with a different physical cell identity (ID), e.g., by SSB configuration or by a field in the TCI state configuration.

In one embodiment, the indication of the two or more SRS resources is via one or more SRIs, and the UE also receives (e.g., is signaled with) a pathloss RS and a set of power control parameters for each of the one or more PUSCHs via the one or more SRI, wherein association between an SRI and one or more pathloss RS and one or more set of power control parameters is signaled.

In one embodiment, the two or more SRS resources belong to either a same SRS set or different SRS resource sets.

In one embodiment, an indication(s) of whether the UE is to use the SDM scheme or the FDM scheme is signaled either semi-statically (e.g., via Radio Resource Control (RRC)) and/or dynamically (e.g., through DCI).

In one embodiment, each PUSCH is scheduled by a separate DCI.

In one embodiment, the two or more TRPs are indicated in the DCI through indication of two or more TCI states, wherein each TRP is associated with one TCI state.

Certain embodiments may provide one or more of the following technical advantage(s). The proposed solutions enable more robust UL data transmission over multiple TRPs with very low latency, where better reliability can be achieved via spatial diversity over the multiple TRPs simultaneously.

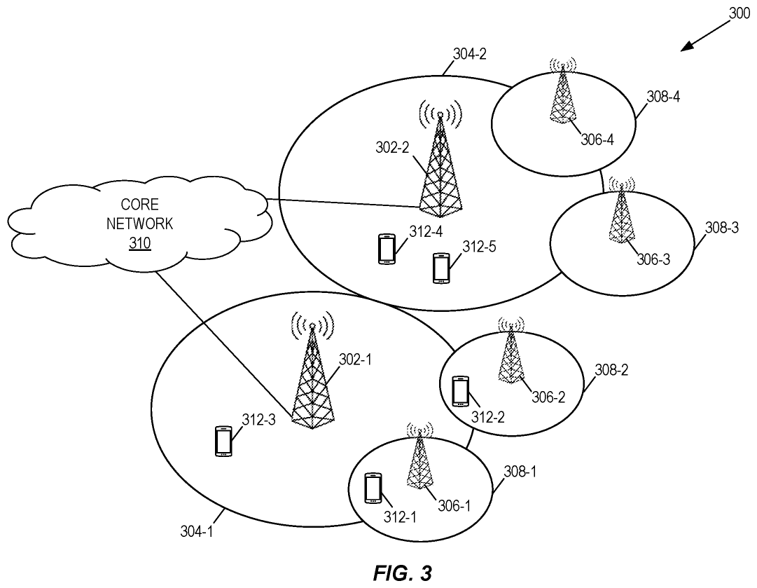

FIG. 3 illustrates one example of a cellular communications system 300 in which embodiments of the present disclosure may be implemented. In the embodiments described herein, the cellular communications system 300 is a 5G System (5GS) including a Next Generation RAN (NG-RAN) and a 5G Core (5GC). In this example, the RAN includes base stations 302-1 and 302-2, which in the 5GS include NR base stations (gNBs) and optionally next generation eNBs (ng-eNBs) (i.e., LTE RAN nodes connected to the 5GC), controlling corresponding (macro) cells 304-1 and 304-2. The base stations 302-1 and 302-2 are generally referred to herein collectively as base stations 302 and individually as base station 302. Likewise, the (macro) cells 304-1 and 304-2 are generally referred to herein collectively as (macro) cells 304 and individually as (macro) cell 304. The RAN may also include a number of low power nodes 306-1 through 306-4 controlling corresponding small cells 308-1 through 308-4. The low power nodes 306-1 through 306-4 can be small base stations (such as pico or femto base stations) or Remote Radio Heads (RRHs), or the like. Notably, while not illustrated, one or more of the small cells 308-1 through 308-4 may alternatively be provided by the base stations 302. The low power nodes 306-1 through 306-4 are generally referred to herein collectively as low power nodes 306 and individually as low power node 306. Likewise, the small cells 308-1 through 308-4 are generally referred to herein collectively as small cells 308 and individually as small cell 308. The cellular communications system 300 also includes a core network 310, which in the 5GS is referred to as the 5G Core (5GC). The base stations 302 (and optionally the low power nodes 306) are connected to the core network 310.

The base stations 302 and the low power nodes 306 provide service to wireless communication devices 312-1 through 312-5 in the corresponding cells 304 and 308. The wireless communication devices 312-1 through 312-5 are generally referred to herein collectively as wireless communication devices 312 and individually as wireless communication device 312. In the following description, the wireless communication devices 312 are oftentimes UEs and as such sometimes referred to herein as UEs 312, but the present disclosure is not limited thereto.

Now, a description of some embodiments of the present disclosure will be provided.

### Simultaneous PUSCH Transmission to Multiple TRPs with Spatial Domain Multiplexing (SDM)

In this embodiment, one or multiple PUSCH(s) for a same Transport Block (TB) is transmitted to multiple TRPs simultaneously, either on the same time and frequency resource or on different frequency resources to different TRPs. Examples of the different TRPs are different base stations 302, different low power nodes 306, a mixture of one or more base stations 302 and one or more lower power nodes 306, or the like. Note that these are non-limiting examples of TRPs. Other examples include remote radio heads, multi-panels, etc.

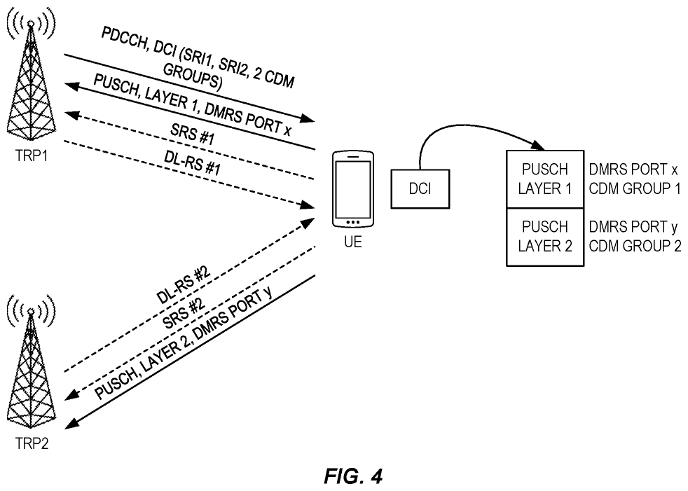

FIG. 4 shows an example of a UE (e.g., a UE 312) transmitting different layers of a PUSCH to two TRPs. The PUSCH with two layers is scheduled by a DCI, with a first layer (Layer 1) transmitted to TRP1 and a second layer (Layer 2) transmitted to TRP2. The first layer is associated with a first SRS resource, and the second layer is associated with a second SRS resource, where the association means that the layer is transmitted on the SRS port(s) of the corresponding SRS resource. In Frequency Range 2 (FR2), each SRS resource is spatially related with either a DL RS (e.g., a CSI-RS or SSB) or another SRS via a spatial relation configuration. In this example, a first DL RS (DL RS #1) is transmitted from TRP1, and a second DL RS (DL RS #2) is transmitted from TRP2. In one example, the two DL RSs belong to two different TCI states and may also have different SSBs as sources for Quasi Co-Located (QCL) relations. Hence, each TRP transmits a different SSB.

In particular, the two SSBs may be possible to configure with different physical cell IDs even if they both are used to the same UE for PUSCH transmissions. That is, the two TRPs transmit SSBs that belong to two different cells and, since the SSB is a source for the QCL relation for the DL RS (target), then the DL RSs are also transmitted from the different cells, respectively. Alternatively, the DL RS belong to a TCI state and the TCI state includes a cell ID indicator so that the different DL RSs can be configured to belong to different cells (i.e., transmitted from TRPs served by different cells, with different cell IDs).

An example of the DL RS is the CSI-RS for tracking, i.e., Tracking Reference Signal (TRS).

A first SRS resource (SRS #1) is spatially related to the first DL RS, and a second SRS resource (SRS #2) is spatially related to the second DL RS. Then, a DCI scheduling the PUSCH is indicated to the UE via a Physical Downlink Control Channel (PDCCH). The two SRS resources are indicated in one or two “SRS resource indicator (SRI)” fields of the DCI. Two DMRS ports (i.e., DMRS ports x and y), each associated to one of the two layers, in two Code Division Multiplexing (CDM) groups (i.e., CDM groups 1 and 2) are also indicated in the DCI. The first SRS resource is linked to the first DMRS port indicated in the DCI field “Antenna Port(s)”, and the second SRS resource is linked to the second DMRS port indicated in the DCI field “Antenna Port(s)”. For codebook-based SRS and if there are more than one SRS port per SRS resource, a transmit precoding matrix indicator (TPMI) is also indicated for each SRS resource. In this example, joint decoding by combining the PUSCH signals received from the two TRPs is needed.

For the embodiment where the UE transmits different layers of a single PUSCH to two TRPs (as shown in the example of FIG. 4), the same time and frequency resources are used to transmit to the two different TRPs.

Although two layers of a single PUSCH is covered in the above example embodiment, this embodiment can be extended to up to more than two layers. For example, the above example embodiment can be extended to up to four layers of a single PUSCH transmitted to up to three TRPs. Some examples are as follows:
In one example, a PUSCH with four layers is scheduled by a DCI, with the 1st and 2^{nd} layers (Layers 1-2) transmitted to TRP1 and the 3^{rd}-4^{th} layers (Layer 3-4) to TRP2. Layers 1-2 are associated with a first SRS resource and layers 3-4 are associated with a second SRS resource, where the association means that the layers are transmitted on the SRS port(s) of the corresponding SRS resource. In this case, the ‘Antenna port(s)’ field can indicate DMRS ports corresponding to 2 CDM groups (one CDM group associated with each TRP).
In another example, a PUSCH with three layers is scheduled by a DCI, with the 1^{st} and 2^{nd} layers (Layers 1-2) transmitted to TRP1 and the 3^{rd} layer (Layer 3) to TRP2. Layers 1-2 are associated with a first SRS resource and layer 3 is associated with a second SRS resource, where the association means that the layers are transmitted on the SRS port(s) of the corresponding SRS resource. In this case, the ‘Antenna port(s)’ field can indicate DMRS ports corresponding to 2 CDM groups (one CDM group associated with each TRP).
In another example, a PUSCH with four layers is scheduled by a DCI, with the 1^{st} and 2^{nd} layers (Layers 1-2) transmitted to TRP1, the 3^{rd} layer (Layer 3) to TRP2, and the 4th layer is transmitted to TRP3. Layers 1-2 are associated with a first SRS resource, layer 3 is associated with a second SRS resource, and layer 4 is associated with a third SRS resource, where the association means that the layers are transmitted on the SRS port(s) of the corresponding SRS resource. In this case, the ‘Antenna port(s)’ field can indicate DMRS ports corresponding to 3 CDM groups (one CDM group associated with each TRP).

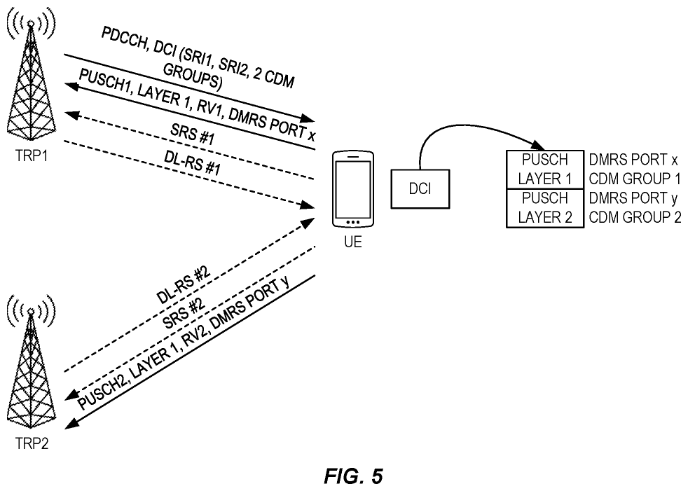

Alternatively, for a same TB or different TBs, separate PUSCHs can be transmitted to each TRP. An example is shown in FIG. 5, where a UE transmits two PUSCHs (PUSCH1 and PUSCH2) for a same TB to two TRPs (TRP1 and TRP2). In this case, PUSCH2 can be considered as a retransmission of the TB with a same or different redundancy version. Again, two SRS resources and DMRS in two CDM groups are indicated in the DCI via the SRI fields and Antenna port(s) fields, respectively. Independent decoding at each TRP can be done in this case if each of the two PUSCH are self-decodable. For the embodiment where the UE transmits two PUSCHs to two TRPs (as shown in the example of FIG. 5), the same time frequency resources are used to transmit to the two different TRPs. Although two PUSCHs of the same TB transmitted to two TRPs is covered in the above example embodiment, this embodiment can be extended to up to NPUSCHs of the same TB with different RVs transmitted to up to N TRPs.

### Simultaneous PUSCH Transmission to Multiple TRPs with Frequency Domain Multiplexing (FDM)

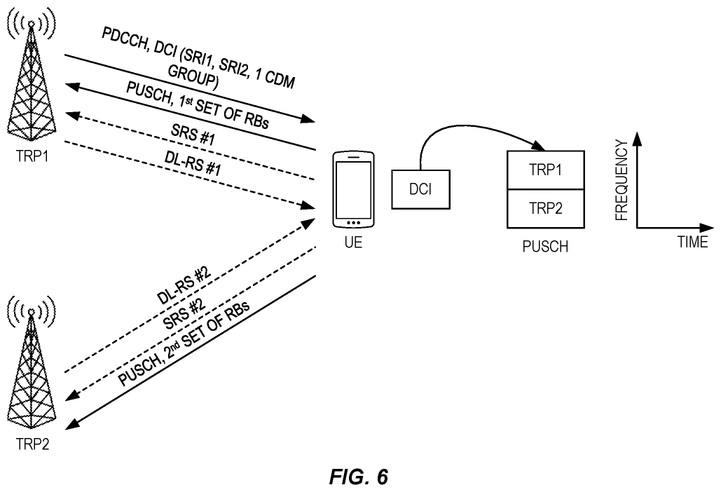

In the examples above, the same time-frequency resource is allocated to both TRPs. In this embodiment, different frequency domain resources are allocated to different TRPs. An example is shown in FIG. 6, where a single PUSCH is transmitted to two TRPs with part of the frequency-domain resource (e.g., part of the RBs) allocated to each TRP. In this case, the same DMRS port(s) may be shared by the two TRPs as different resources are used and, thus, a single CDM group can be allocated. Joint decoding by combining the PUSCH signals received from the two TRPs is needed.

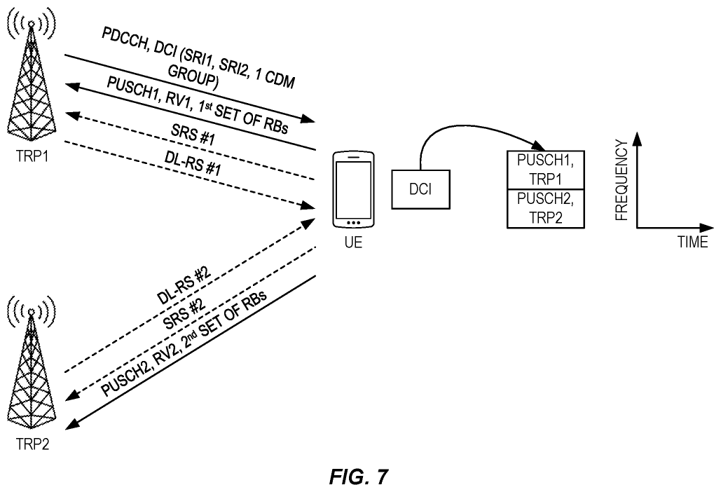

Alternatively, for a same TB or different TBs, a separate PUSCH is sent to each TRP on different frequency domain resources. An example is shown in FIG. 7, where a UE transmits two PUSCHs (PUSCH1 and PUSCH2) for a same TB to two TRPs (TRP1 and TRP2). In this case, PUSCH2 can be considered as a retransmission of the same TB with a same or different redundancy version (RV). Again, two SRS resources and one CDM group are indicated in the DCI. Independent decoding at each TRP can be done in this case if each of the two PUSCHs is self-decodable.

A single frequency resource allocation may be signaled, and the frequency resource is then divided between the two TRPs. In one embodiment, if N RBs are allocated, the first N/2 RBs are allocated to the first TRP and the remaining RBs are allocated to the second TRP. Alternatively, the even numbered RBs (or subcarriers) are allocated to the first TRP and the odd number of RBs (or subcarriers) are allocated to the second TRPs, or the other way around.

In one embodiment, in case of two PUSCHs (e.g., PUSCH1 and PUSCH2) are used, the TB size is determined based on the number of RBs (or subcarriers) allocated to the first TRP.

### Configuration of the UE to Use Either SDM Scheme or FDM Scheme

In some embodiments, the choice among which of the PUSCH transmission schemes among the SDM or FDM schemes and the variants covered above is configured to the UE with higher layer (e.g., RRC) signaling. That is, when the network configures the UE with ‘FDM’ scheme, then the UE assumes PUSCH multi-TRP transmission scheme according to the embodiment described above in the section “Simultaneous PUSCH Transmission to Multiple TRPs with Frequency Domain Multiplexing (FDM)”. In another embodiment, whether the UE is to use ‘SDM’ or ‘FDM’ multi-TRP PUSCH transmission is indicated jointly by the Antenna Ports field and the SRI field in UL DCI as follows:
If the ‘Antenna Ports’ field indicates DMRS ports from 2 CDM groups and if the SRI field indicates two SRS resources, then the UE assumes SDM scheme
If the ‘Antenna Ports’ field indicates DMRS ports from 1 CDM groups and if the SRI field indicates two SRS resources, then the UE assumes FDM scheme

### PUSCH Power Control

For codebook based PUSCH transmission, in one embodiment, a single SRS resource set with two or more SRS resources is configured for a UE. Each of the two or more SRS resources is associated to a TRP via a spatial relation configuration, which includes a DL RS (or pathloss RS) for pathloss measurement and estimation. A set of PUSCH power control related parameters is also associated to an SRS resource. When one or more PUSCHs transmitted to two TRPs are scheduled by a DCI, two SRS resources are also indicated in the DCI. The transmit power of the PUSCH to each TRP can be calculated based on the pathloss estimation and the set of power control parameters associated to the corresponding SRS resource.

In another embodiment, two SRS resource sets each with one or more SRS resource are configured for a UE. Each of the SRS resource sets is associated with a DL RS for pathloss measurement and with a set of PUSCH power control related parameters. When one or more PUSCHs transmitted to two TRPs are scheduled by a DCI, two SRS resources, one in each SRS resource set, are indicated in the DCI. The transmit power of the one or more PUSCHs to each TRP can be calculated based on the estimated pathloss and the power control parameters associated to the corresponding SRS resource set.

For non-codebook based PUSCH transmission, two SRS resource sets can be configured for a UE. Each of the SRS resource sets is associated with a DL RS for pathloss calculation and also a set of power control related parameters. When one or more PUSCHs transmitted to two TRPs are scheduled by a DCI, SRS resource(s) in each SRS resource set are indicated in the DCI. The transmit power of the one or more PUSCHs to each TRP can be calculated based on the estimated pathloss and the power control parameters associated to the corresponding SRS resource set.

In case of codebook based PUSCH transmission, one or two SRS resources may be indicated in DCI for PUSCH transmission to one or two TRPs, respectively. For non-codebook based transmission, one or two SRS resource sets may be indicated in DCI for PUSCH transmission to one or two TRPs, respectively. If one SRS resource is indicated, a PUSCH towards a single TRP is scheduled. On the other hand, if two SRS resources are indicated, one or more PUSCH is scheduled towards two TRPs.

Two SRI fields, one for each TRP, may be used in a DCI for scheduling a PUSCH. To support dynamic switching between a single TRP and two TRPs, each SRI field may also include a codepoint to indicate the corresponding SRS resource is not selected.

To support independent power control of PUSCH to each TRP, separate TPC commands may be included in a DCI for each TRP. The “TPC command for scheduled PUSCH” field in DCI 0_1 and DCI 0_2 may be extended from 2 bits to 4 bits, with 2 bits each for each TRP.

### UCI on PUSCH

Uplink Control Information (UCI) such as Hybrid Automatic Repeat Request Acknowledgement (HARQ-Ack), CSI feedback, or scheduling request (SR) on a PUCCH resource may be present is a same slot as a PUSCH. In this case, the UCI is carried on the PUSCH (instead of the PUCCH). How to multiplex the UCI and the PUSCH is a problem.

In one embodiment, if two PUSCHs, each toward a different TRP, overlaps with the PUCCH in one or more symbols in a slot and that the PUCCH has a same spatial relation as one of the two PUSCHs, the UCI is transmitted on both of the PUSCHs to both TRPs. Alternatively, the UCI is only transmitted on the PUSCH that has a same spatial relation as the overlapped PUCCH.

If UE is provided ACKNACKFeedbackMode=JointFeedback, the UCI is transmitted on both PUSCHs if the PUCCH overlaps with the PUSCHs with at least one symbol.

In another embodiment, a higher layer configuration may be provided to UE that UE always multiplex the UCI on PUSCH regardless of the spatial relations.

### DCI Indication

Besides the “TPC command for scheduled PUSCH” mentioned above in the section “PUSCH Power Control”, one or several of the DCI bit fields in DCI format 0_1 and 0_2 may be extended to have more bits in an existing field (i.e., joint encoding for 2 TRPs) or to add a new field (for the second TRP) to support 2 PUSCH transmission to two TRPs:
Precoding information and number of layers
Antenna ports
SRS request
PTRS-DMRS association
DMRS sequence initialization
1^{st} downlink assignment index
2^{nd} downlink assignment index

Though the UE may switch between single TRP mode and multi-TRP mode based on indication in received DCI, the DCI fields for each format 0_1 and 0_2, as well as the size of each field shall be aligned. Either truncation or padding can be applied to align each DCI field size. For example, a number of most significant bits with value set to ‘0’ are inserted to smaller bit width (i.e., single TRP) until the bit width for single TRP and Multi-TRP are the same.

If the enabling of PUSCH multi-TRP is configured per CORESET or per SearchSpace, each DCI field size shall be aligned per CORESET or per SearchSpace, and the total DCI payload size for the same format shall be aligned across all the CORESETs and SearchSpaces.

### Further Description

Although the discussion above focused on simultaneous PUSCH transmissions (e.g., PUSCH1 and PUSCH2) to two TRPs for a same TB, the embodiments can be easily extended to different TBs (e.g., PUSCH1 carries TB1 while PUSCH2 carries TB2). In addition, single DCI based scheduling is discussed above for PUSCH transmission; however, the embodiments can be extended to multi-DCI based scheduling in which the PUSCH to each TRP is scheduled by a separate DCI.

Furthermore, one or more SRIs are used to indicate the PUSCH transmission directions in the embodiments described above. However, in another embodiment, UL TCI states may be used instead for indicating PUSCH transmission directions. For example, two UL TCI states may be signaled in a DCI to indicate a PUSCH transmission to two TRPs.

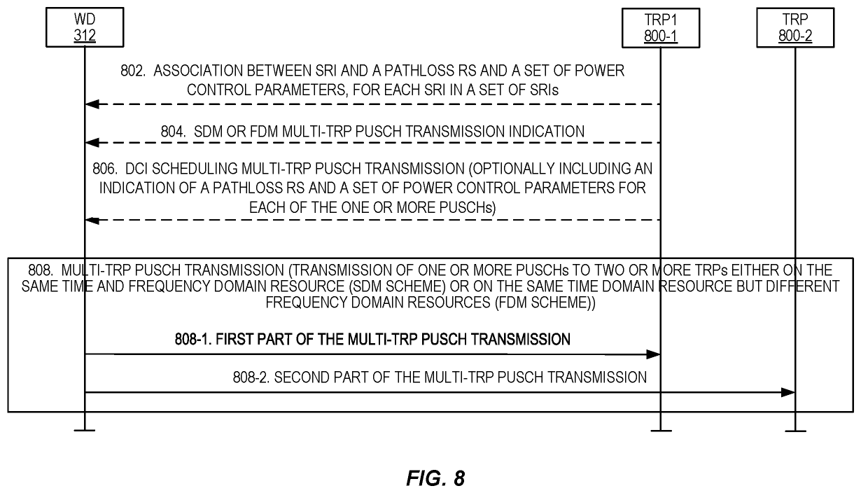

FIG. 8 illustrates the operation of a wireless communication device 312 (e.g., a UE) and two TRPs 800-1 and 800-2 in accordance with at least some of the embodiments described above. Note that optional steps are represented by dashed lines/boxes. As illustrated, in one embodiment, the wireless communication device 312 receives, from a network node (e.g., TRP1 in this example), DCI that schedules transmission of one or more PUSCHs to TRP1 and TRP2, simultaneously, on a same time and frequency domain resource or on a same time domain resource but different frequency domain resources (step 806).

The wireless communication device 312 transmits one or more PUSCHs (e.g., the PUSCH(s) scheduled by the DCI of step 806) to TRP1 and TRP2 on a same time and frequency domain resource or on a same time domain resource but different frequency domain resources (step 808). As discussed above, each TRP is associated with a different reference signal. The transmission includes a first part that is transmitted to TRP1 (step 808-1) and a second part that is simultaneously transmitted to TRP2 (step 808-2). For example, the first part and the second part are different layers of the same PUSCH transmitted on the same time and frequency domain resources (see, e.g., FIG. 4). As another example, the first part and the second part are different PUSCH transmissions of different RVs of the same TB transmitted on the same time and frequency domain resources (see, e.g., FIG. 5). As another example, the first part and the second part are the same PUSCH transmitted on the same time domain resource but different frequency domain resources (see, e.g., FIG. 6). As another example, the first part and the second part are separate PUSCH transmission of different RVs of the same TB transmitted on the same time domain resource but different frequency domain resources (see, e.g., FIG. 7).

The details described above regarding the DCI received by the wireless communication device 312 (e.g., the UE) to schedule a multi-TRP PUSCH transmission are applicable to the process of FIG. 8. Some of those details are repeated here; however, note that other details that are not repeated here are also applicable. In one embodiment, the DCI indicates two or more reference signals. In one embodiment, the two or more reference signals are two or more downlink reference signals each associated with a respective TCI state.

In another embodiment, the two or more reference signals are two or more SRS resources, each configured with a respective spatial relation. In one embodiment, the DCI comprises one or more SRIs that indicate the two or more SRS resources. In one embodiment, each of the two or more SRS resources is associated with a respective reference signal through a spatial relation configuration. In one embodiment, the respective reference signal is an SSB, a NZP CSI-RS, or another SRS. In one embodiment, the two or more SRS resources are associated with two or more respective reference signals, and the two or more respective reference signals are associated with two or more respective cell IDs (i.e., each respective reference signal is associated with a different cell ID). In one embodiment, the two or more respective reference signals are two or more respective SSBs or two or more respective NZP CSI-RSs. In one embodiment, the two or more respective reference signals are associated with the two or more respective cell IDs via a field in a TCI state configuration. In one embodiment, the two or more respective reference signals are two or more respective SSBs, and the two or more reference signals are associated with the two or more respective cell IDs via SSB configuration.

In one embodiment, the wireless communication device 312 further receives, from a network node (e.g., TRP1 in this example), an indication of a pathloss reference signal and a set of power control parameters for each of the one or more PUSCHs via the one or more SRI, wherein association between an SRI and one or more pathloss reference signals and one or more sets of power control parameters is signaled to the wireless communication device. In this example, the indication of the pathloss reference signal and the set of power control parameters for each of the one or more PUSCHs is included in the DCI and, more specifically, is provided by the SRI(s). In other words, in one embodiment, the wireless communication device 312 receives information that defines, for each SRI of a set of SRIs, an association between the SRI and one or more pathloss reference signals and one or more sets of power control parameters (step 802). In other words, as described in the section entitled “PUSCH Power Control” above, the wireless communication device 312 may receive a configuration of a pathloss reference signal and a set of power control related parameters for each SRS resource (e.g., in the case of a single SRS resource set) or for each SRS resource set (e.g., in the case of two (or more) SRS resource sets). The wireless communication device 312 then receives an indication of a pathloss reference signal and a set of power control parameters for each of the one or more PUSCHs via the one or more SRIs included in the DCI of step 806. In one embodiment, in step 808, the wireless communication device 312 transmits the one or more PUSCHs to the two or more TRPs in accordance the indicated set of power control parameters for each of the one or more PUSCHs.

In one embodiment, the two or more SRS resources belong to either a same SRS resource set or different SRS resource sets.

In one embodiment, the wireless communication device 312 receives, from a network node (e.g., TRP1 in this example), an indication to use either the SDM for multi-TRP PUSCH transmission or the FDM scheme for multi-TRP PUSCH transmission (step 804). In this case, in step 808, the wireless communication device 312 transmits the one or more PUSCHs to the TRPs on the same time and frequency domain resource if the received indication is an indication to use the SDM scheme for multi-TRP PUSCH transmission or on the same time domain resource but different frequency domain resources if the received indication is an indication to use the FDM scheme for multi-TRP PUSCH transmission.

In one example alternative embodiment, the one or more PUSCHs comprise two or more PUSCHs, and each PUSCH of the two or more PUSCHs is scheduled via a separate downlink control information.

In one embodiment, the TRPs to which the PUSCH(s) are simultaneously transmitted are indicated in the DCI through indication of two or more TCI states, wherein each TRP is associated with one TCI state.

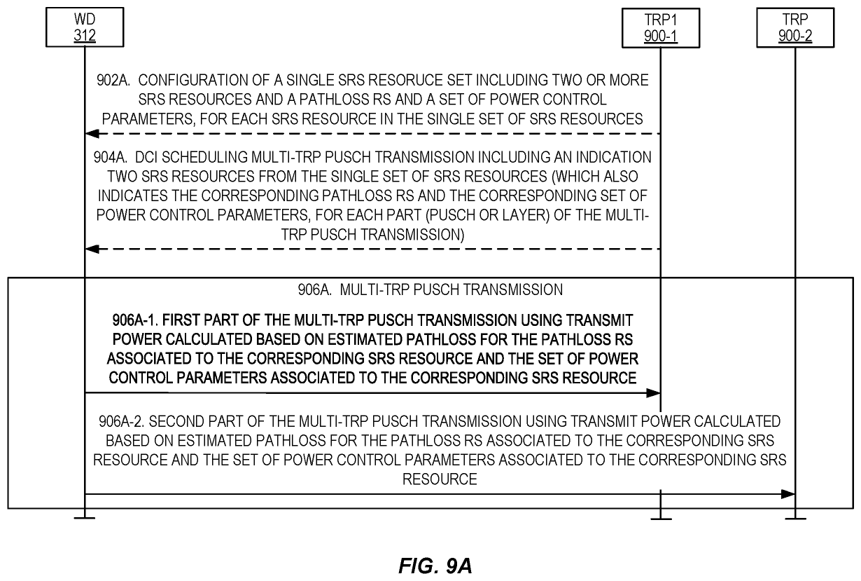

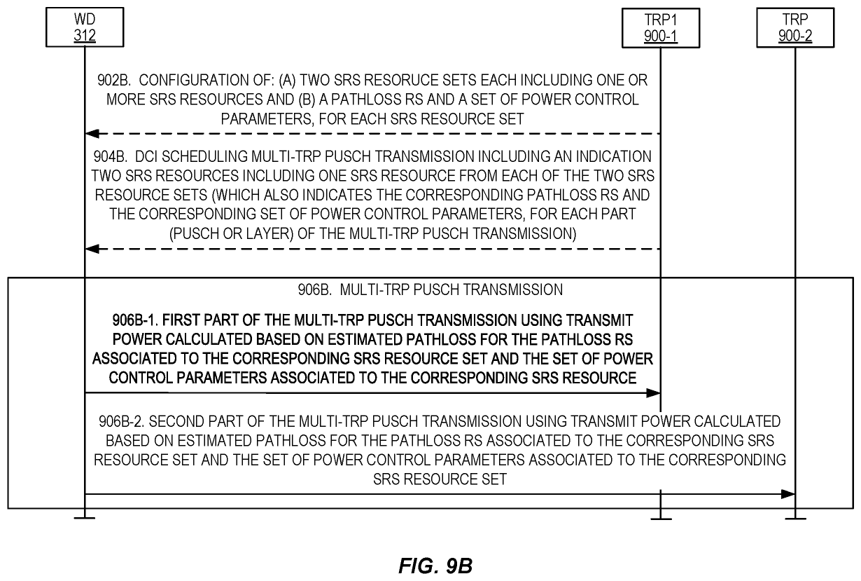

FIGS. 9A and 9B illustrates the operation of a wireless communication device 312 (e.g., a UE) and two TRPs 800-1 and 800-2 in accordance with at least some of the embodiments described above, particularly those described above in the section “PUSCH Power Control”. As illustrated in FIG. 9A, in one embodiment, the wireless communication device 312 receives, from a network node (e.g., TRP1 in this example), configuration of a single SRS resource set that includes two or more SRS resources (step 902A). As described above, each of the two or more SRS resources (in the single SRS resource set) is associated to a TRP via a spatial relation configuration, which includes a DL RS (or pathloss RS) for pathloss measurement and estimation. A set of PUSCH power control related parameters is also associated to an SRS resource. In other words, each SRS resource in the single SRS resource set is associated to a corresponding pathloss RS and a corresponding set of power control related parameters.

The wireless communication device 312 receives DCI that schedules transmission of one or more PUSCHs to TRP1 900-1 and TRP2 900-2 (step 904A). In other words, the received DCI schedules a PUSCH transmission that includes a first part that is to be transmitted to TRP1 900-1 (e.g., and is therefore associated to a first SRS resource indicted in the DCI or a first TCI state) and a second part that is to be transmitted to TRP2 900-2 (e.g., and is therefore associated to a second SRS resource indicated in the DCI or a second TCI state). The DCI indicates two SRS resources (i.e., a first SRS resource and second SRS resource) from the single SRS resource set configured in step 902A. Indication of the first SRS resource in the DCI is also an indication of the corresponding pathloss RS and set of PUSCH power control related parameters that are associated to the first SRS resource. Likewise, the indication of the second SRS resource in the DCI is also an indication of the corresponding pathloss RS and set of PUSCH power control related parameters that are associated to the second SRS resource. Also, the first SRS resource is associated to TRP1 900-1 (or the first TCI state), and the second SRS resource is associated to TRP2 900-2 (or the second TCI state).

The wireless communication device 312 transmits the one or more PUSCHs in accordance with the DCI (step 906A). More specifically, the PUSCH transmission of step 906A includes the first part that is transmitted to TRP1 900-1 (e.g., transmitted using the first TCI state) using a transmit power that is calculated based on a pathloss estimated that is based on the pathloss reference signal associated to the first SRS resource indicated by the DCI (step 906A-1). The PUSCH transmission of step 906A also includes transmission of the second part to TRP2 900-2 (e.g., transmitted using the second TCI state) using a transmit power that is calculated based on a pathloss estimate that is based on the pathloss reference signal associated to the second SRS resource indicated by the DCI (step 906A-2). For example, the first part and the second part are different layers of the same PUSCH transmitted. As another example, the first part and the second part are different PUSCH transmissions of different RVs of the same TB.

As illustrated in FIG. 9B, in another embodiment, the wireless communication device 312 receives, from a network node (e.g., TRP1 900-1 in this example), configuration of a two SRS resource sets each including one or more SRS resources (step 902B). As described above, each of the two SRS resource sets is associated with a DL RS (or pathloss RS) for pathloss measurement and estimation and a set of PUSCH power control related parameters. The wireless communication device 312 receives DCI that schedules transmission of one or more PUSCHs to TRP1 900-1 and TRP2 900-2 (step 904B). In other words, the received DCI schedules a PUSCH transmission that includes a first part that is to be transmitted to TRP1 900-1 (e.g., and is therefore associated to a first SRS resource from the first SRS resource set indicated in the DCI or a first TCI state) and a second part that is to be transmitted to TRP2 900-2 (e.g., and is therefore associated to a second SRS resource from the second SRS resource set indicated in the DCI or a second TCI state). The DCI indicates two SRS resources including a first SRS resource from the first SRS resource set (which is thereby associated to the corresponding pathloss RS and set of PUSCH power control related parameters that are associated to the first SRS resource set) and a second SRS resource from the second SRS resource set (which is thereby associated to the corresponding pathloss RS and set of PUSCH power control related parameters that are associated to the second SRS resource set). Also, the first SRS resource is associated to TRP1 900-1 (or the first TCI state), and the second SRS resource is associated to TRP2 900-2 (or the second TCI state).

The wireless communication device 312 transmits the one or more PUSCHs in accordance with the DCI (step 906A). More specifically, the PUSCH transmission of step 906A includes the first part that is transmitted to TRP1 900-1 (e.g., transmitted using the first TCI state) using a transmit power that is calculated based on a pathloss estimated that is based on the pathloss reference signal associated to the first SRS resource indicated by the DCI (step 906A-1). The PUSCH transmission of step 906A also includes transmission of the second part to TRP2 900-2 (e.g., transmitted using the second TCI state) using a transmit power that is calculated based on a pathloss estimate that is based on the pathloss reference signal associated to the second SRS resource indicated by the DCI (step 906A-2). For example, the first part and the second part are different layers of the same PUSCH transmitted. As another example, the first part and the second part are different PUSCH transmissions of different RVs of the same TB.

As discussed above, the DCI of step 904A or 904B includes, in one embodiment, two SRI fields, one to indicate the SRS resource for each of the TRPs 900-1 and 900-2. In one embodiment, to support dynamic switching between a single TRP and two TRPs, each SRI field may also include a codepoint to indicate the corresponding SRS resource is not selected, as described above.

In one embodiment, to support independent power control of PUSCH to each TRP, separate TPC commands may be included in the DCI of step 904A or 904B for each of the TRPs 900-1 and 900-2, as described above. In one embodiment, the “TPC command for scheduled PUSCH” field in DCI 0_1 and DCI 0_2 may be extended from 2 bits to 4 bits, with 2 bits each for each TRP, as described above.

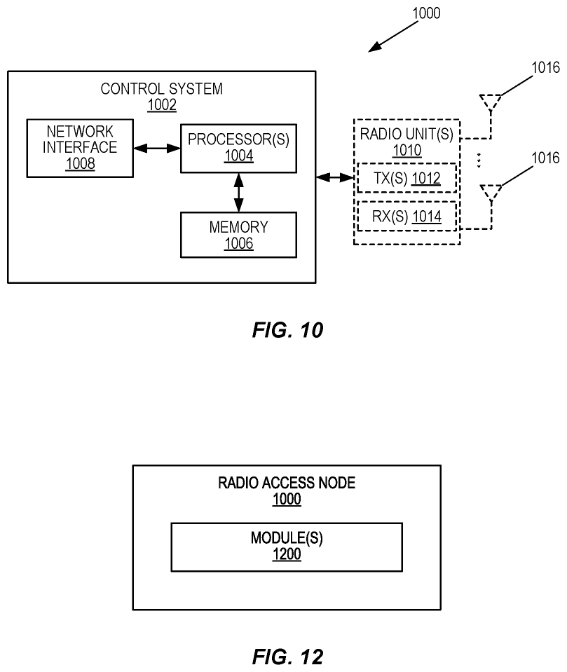

FIG. 10 is a schematic block diagram of a radio access node 1000 according to some embodiments of the present disclosure. Optional features are represented by dashed boxes. The radio access node 1000 may be, for example, TRP as described herein. As illustrated, the radio access node 1000 includes a control system 1002 that includes one or more processors 1004 (e.g., Central Processing Units (CPUs), Application Specific Integrated Circuits (ASICs), Field Programmable Gate Arrays (FPGAs), and/or the like), memory 1006, and a network interface 1008. The one or more processors 1004 are also referred to herein as processing circuitry. In addition, the radio access node 1000 may include one or more radio units 1010 that each includes one or more transmitters 1012 and one or more receivers 1014 coupled to one or more antennas 1016. The radio units 1010 may be referred to or be part of radio interface circuitry. In some embodiments, the radio unit(s) 1010 is external to the control system 1002 and connected to the control system 1002 via, e.g., a wired connection (e.g., an optical cable). However, in some other embodiments, the radio unit(s) 1010 and potentially the antenna(s) 1016 are integrated together with the control system 1002. The one or more processors 1004 operate to provide one or more functions of a radio access node 1000 as described herein (e.g., one or more functions of a TRP as described herein). In some embodiments, the function(s) are implemented in software that is stored, e.g., in the memory 1006 and executed by the one or more processors 1004.

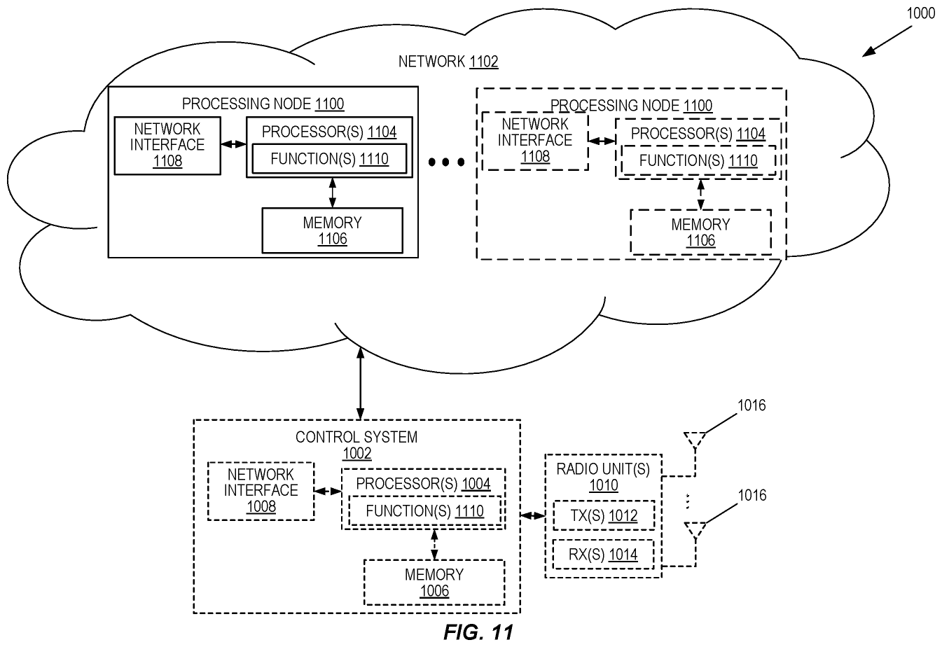

FIG. 11 is a schematic block diagram that illustrates a virtualized embodiment of the radio access node 1000 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1000 in which at least a portion of the functionality of the radio access node 1000 is implemented as a virtual component(s) (e.g., via a virtual machine(s) executing on a physical processing node(s) in a network(s)). As illustrated, in this example, the radio access node 1000 may include the control system 1002 and/or the one or more radio units 1010, as described above. The control system 1002 may be connected to the radio unit(s) 1010 via, for example, an optical cable or the like. The radio access node 1000 includes one or more processing nodes 1100 coupled to or included as part of a network(s) 1102. If present, the control system 1002 or the radio unit(s) are connected to the processing node(s) 1100 via the network 1102. Each processing node 1100 includes one or more processors 1104 (e.g., CPUs, ASICs, FPGAs, and/or the like), memory 1106, and a network interface 1108.

In this example, functions 1110 of the radio access node 1000 described herein (e.g., one or more functions of a TRP) are implemented at the one or more processing nodes 1100 or distributed across the one or more processing nodes 1100 and the control system 1002 and/or the radio unit(s) 1010 in any desired manner. In some particular embodiments, some or all of the functions 1110 of the radio access node 1000 described herein are implemented as virtual components executed by one or more virtual machines implemented in a virtual environment(s) hosted by the processing node(s) 1100. As will be appreciated by one of ordinary skill in the art, additional signaling or communication between the processing node(s) 1100 and the control system 1002 is used in order to carry out at least some of the desired functions 1110. Notably, in some embodiments, the control system 1002 may not be included, in which case the radio unit(s) 1010 communicate directly with the processing node(s) 1100 via an appropriate network interface(s).

In some embodiments, a computer program including instructions which, when executed by at least one processor, causes the at least one processor to carry out the functionality of radio access node 1000 or a node (e.g., a processing node 1100) implementing one or more of the functions 1110 of the radio access node 1000 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 12 is a schematic block diagram of the radio access node 1000 according to some other embodiments of the present disclosure. The radio access node 1000 includes one or more modules 1200, each of which is implemented in software. The module(s) 1200 provide the functionality of the radio access node 1000 described herein (e.g., functionality of a TRP as described herein). This discussion is equally applicable to the processing node 1100 of FIG. 11 where the modules 1200 may be implemented at one of the processing nodes 1100 or distributed across multiple processing nodes 1100 and/or distributed across the processing node(s) 1100 and the control system 1002.

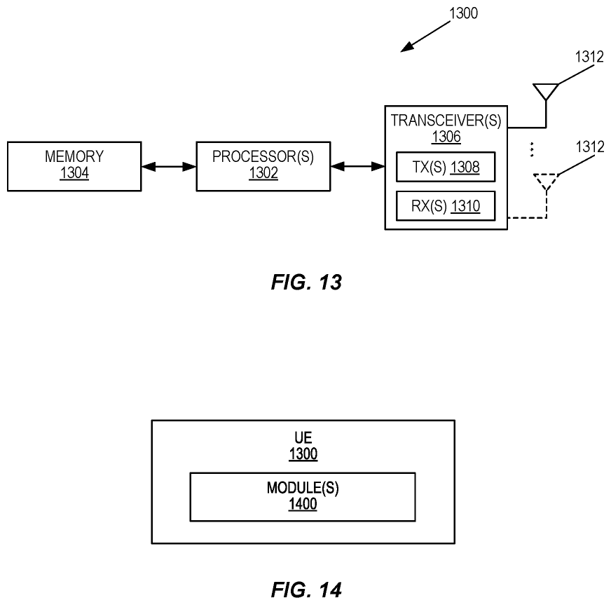

FIG. 13 is a schematic block diagram of a wireless communication device 1300 according to some embodiments of the present disclosure. The wireless communication device 1300 may be the wireless communication device Q112 or a UE, as described herein. As illustrated, the wireless communication device 1300 includes one or more processors 1302 (e.g., CPUs, ASICs, FPGAs, and/or the like), memory 1304, and one or more transceivers 1306 each including one or more transmitters 1308 and one or more receivers 1310 coupled to one or more antennas 1312. The transceiver(s) 1306 includes radio-front end circuitry connected to the antenna(s) 1312 that is configured to condition signals communicated between the antenna(s) 1312 and the processor(s) 1302, as will be appreciated by on of ordinary skill in the art. The processors 1302 are also referred to herein as processing circuitry. The transceivers 1306 are also referred to herein as radio circuitry. In some embodiments, the functionality of the wireless communication device 1300 described above (e.g., the functionality of the wireless communication device 312 or UE as described herein) may be fully or partially implemented in software that is, e.g., stored in the memory 1304 and executed by the processor(s) 1302. Note that the wireless communication device 1300 may include additional components not illustrated in FIG. 13 such as, e.g., one or more user interface components (e.g., an input/output interface including a display, buttons, a touch screen, a microphone, a speaker(s), and/or the like and/or any other components for allowing input of information into the wireless communication device 1300 and/or allowing output of information from the wireless communication device 1300), a power supply (e.g., a battery and associated power circuitry), etc.

In some embodiments, a computer program including instructions which, when executed by at least one processor, causes the at least one processor to carry out the functionality of the wireless communication device 1300 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 14 is a schematic block diagram of the wireless communication device 1300 according to some other embodiments of the present disclosure. The wireless communication device 1300 includes one or more modules 1400, each of which is implemented in software. The module(s) 1400 provide the functionality of the wireless communication device 1300 described herein (e.g., the functionality of the wireless communication device 312 or UE as described herein).

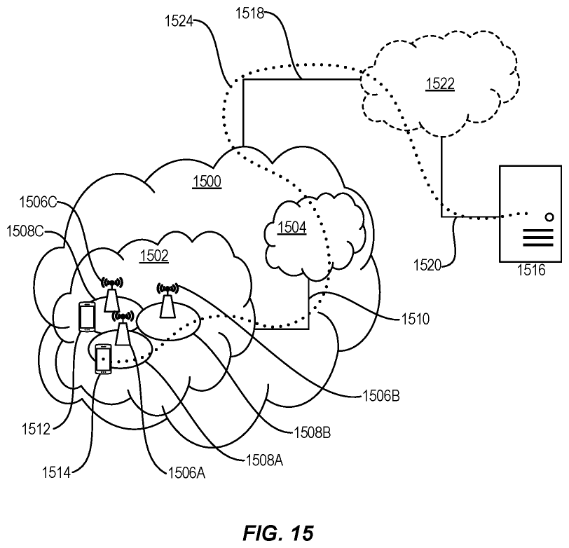

With reference to FIG. 15, in accordance with an embodiment, a communication system includes a telecommunication network 1500, such as a 3GPP-type cellular network, which comprises an access network 1502, such as a RAN, and a core network 1504. The access network 1502 comprises a plurality of base stations 1506A, 1506B, 1506C, such as Node Bs, eNBs, gNBs, or other types of wireless Access Points (APs), each defining a corresponding coverage area 1508A, 1508B, 1508C. Each base station 1506A, 1506B, 1506C is connectable to the core network 1504 over a wired or wireless connection 1510. A first UE 1512 located in coverage area 1508C is configured to wirelessly connect to, or be paged by, the corresponding base station 1506C. A second UE 1514 in coverage area 1508A is wirelessly connectable to the corresponding base station 1506A. While a plurality of UEs 1512, 1514 are illustrated in this example, the disclosed embodiments are equally applicable to a situation where a sole UE is in the coverage area or where a sole UE is connecting to the corresponding base station 1506.

The telecommunication network 1500 is itself connected to a host computer 1516, which may be embodied in the hardware and/or software of a standalone server, a cloud-implemented server, a distributed server, or as processing resources in a server farm. The host computer 1516 may be under the ownership or control of a service provider, or may be operated by the service provider or on behalf of the service provider. Connections 1518 and 1520 between the telecommunication network 1500 and the host computer 1516 may extend directly from the core network 1504 to the host computer 1516 or may go via an optional intermediate network 1522. The intermediate network 1522 may be one of, or a combination of more than one of, a public, private, or hosted network; the intermediate network 1522, if any, may be a backbone network or the Internet; in particular, the intermediate network 1522 may comprise two or more sub-networks (not shown).

The communication system of FIG. 15 as a whole enables connectivity between the connected UEs 1512, 1514 and the host computer 1516. The connectivity may be described as an Over-the-Top (OTT) connection 1524. The host computer 1516 and the connected UEs 1512, 1514 are configured to communicate data and/or signaling via the OTT connection 1524, using the access network 1502, the core network 1504, any intermediate network 1522, and possible further infrastructure (not shown) as intermediaries. The OTT connection 1524 may be transparent in the sense that the participating communication devices through which the OTT connection 1524 passes are unaware of routing of uplink and downlink communications. For example, the base station 1506 may not or need not be informed about the past routing of an incoming downlink communication with data originating from the host computer 1516 to be forwarded (e.g., handed over) to a connected UE 1512. Similarly, the base station 1506 need not be aware of the future routing of an outgoing uplink communication originating from the UE 1512 towards the host computer 1516.

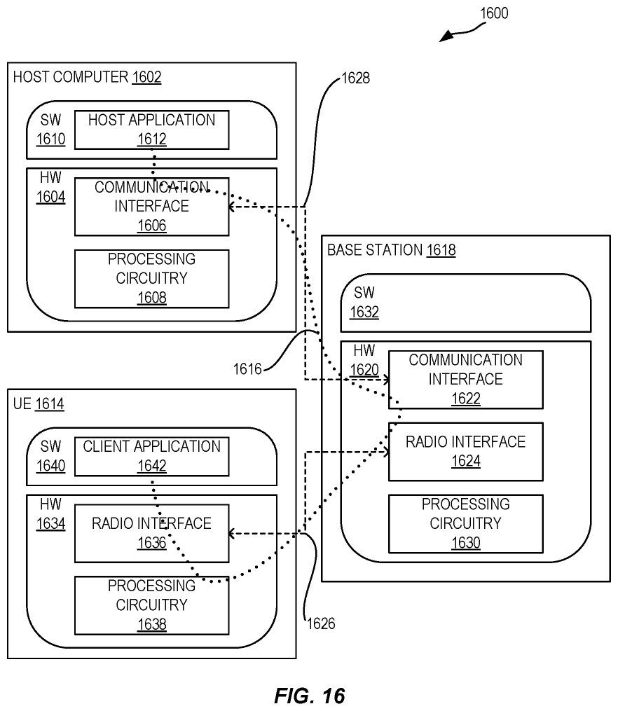

Example implementations, in accordance with an embodiment, of the UE, base station, and host computer discussed in the preceding paragraphs will now be described with reference to FIG. 16. In a communication system 1600, a host computer 1602 comprises hardware 1604 including a communication interface 1606 configured to set up and maintain a wired or wireless connection with an interface of a different communication device of the communication system 1600. The host computer 1602 further comprises processing circuitry 1608, which may have storage and/or processing capabilities. In particular, the processing circuitry 1608 may comprise one or more programmable processors, ASICs, FPGAs, or combinations of these (not shown) adapted to execute instructions. The host computer 1602 further comprises software 1610, which is stored in or accessible by the host computer 1602 and executable by the processing circuitry 1608. The software 1610 includes a host application 1612. The host application 1612 may be operable to provide a service to a remote user, such as a UE 1614 connecting via an OTT connection 1616 terminating at the UE 1614 and the host computer 1602. In providing the service to the remote user, the host application 1612 may provide user data which is transmitted using the OTT connection 1616.

The communication system 1600 further includes a base station 1618 provided in a telecommunication system and comprising hardware 1620 enabling it to communicate with the host computer 1602 and with the UE 1614. The hardware 1620 may include a communication interface 1622 for setting up and maintaining a wired or wireless connection with an interface of a different communication device of the communication system 1600, as well as a radio interface 1624 for setting up and maintaining at least a wireless connection 1626 with the UE 1614 located in a coverage area (not shown in FIG. 16) served by the base station 1618. The communication interface 1622 may be configured to facilitate a connection 1628 to the host computer 1602. The connection 1628 may be direct or it may pass through a core network (not shown in FIG. 16) of the telecommunication system and/or through one or more intermediate networks outside the telecommunication system. In the embodiment shown, the hardware 1620 of the base station 1618 further includes processing circuitry 1630, which may comprise one or more programmable processors, ASICs, FPGAs, or combinations of these (not shown) adapted to execute instructions. The base station 1618 further has software 1632 stored internally or accessible via an external connection.

The communication system 1600 further includes the UE 1614 already referred to. The UE's 1614 hardware 1634 may include a radio interface 1636 configured to set up and maintain a wireless connection 1626 with a base station serving a coverage area in which the UE 1614 is currently located. The hardware 1634 of the UE 1614 further includes processing circuitry 1638, which may comprise one or more programmable processors, ASICs, FPGAs, or combinations of these (not shown) adapted to execute instructions. The UE 1614 further comprises software 1640, which is stored in or accessible by the UE 1614 and executable by the processing circuitry 1638. The software 1640 includes a client application 1642. The client application 1642 may be operable to provide a service to a human or non-human user via the UE 1614, with the support of the host computer 1602. In the host computer 1602, the executing host application 1612 may communicate with the executing client application 1642 via the OTT connection 1616 terminating at the UE 1614 and the host computer 1602. In providing the service to the user, the client application 1642 may receive request data from the host application 1612 and provide user data in response to the request data. The OTT connection 1616 may transfer both the request data and the user data. The client application 1642 may interact with the user to generate the user data that it provides.

It is noted that the host computer 1602, the base station 1618, and the UE 1614 illustrated in FIG. 16 may be similar or identical to the host computer 1516, one of the base stations 1506A, 1506B, 1506C, and one of the UEs 1512, 1514 of FIG. 15, respectively. This is to say, the inner workings of these entities may be as shown in FIG. 16 and independently, the surrounding network topology may be that of FIG. 15.

In FIG. 16, the OTT connection 1616 has been drawn abstractly to illustrate the communication between the host computer 1602 and the UE 1614 via the base station 1618 without explicit reference to any intermediary devices and the precise routing of messages via these devices. The network infrastructure may determine the routing, which may be configured to hide from the UE 1614 or from the service provider operating the host computer 1602, or both. While the OTT connection 1616 is active, the network infrastructure may further take decisions by which it dynamically changes the routing (e.g., on the basis of load balancing consideration or reconfiguration of the network).

The wireless connection 1626 between the UE 1614 and the base station 1618 is in accordance with the teachings of the embodiments described throughout this disclosure. One or more of the various embodiments improve the performance of OTT services provided to the UE 1614 using the OTT connection 1616, in which the wireless connection 1626 forms the last segment.

A measurement procedure may be provided for the purpose of monitoring data rate, latency, and other factors on which the one or more embodiments improve. There may further be an optional network functionality for reconfiguring the OTT connection 1616 between the host computer 1602 and the UE 1614, in response to variations in the measurement results. The measurement procedure and/or the network functionality for reconfiguring the OTT connection 1616 may be implemented in the software 1610 and the hardware 1604 of the host computer 1602 or in the software 1640 and the hardware 1634 of the UE 1614, or both. In some embodiments, sensors (not shown) may be deployed in or in association with communication devices through which the OTT connection 1616 passes; the sensors may participate in the measurement procedure by supplying values of the monitored quantities exemplified above, or supplying values of other physical quantities from which the software 1610, 1640 may compute or estimate the monitored quantities. The reconfiguring of the OTT connection 1616 may include message format, retransmission settings, preferred routing, etc.; the reconfiguring need not affect the base station 1618, and it may be unknown or imperceptible to the base station 1618. Such procedures and functionalities may be known and practiced in the art. In certain embodiments, measurements may involve proprietary UE signaling facilitating the host computer 1602's measurements of throughput, propagation times, latency, and the like. The measurements may be implemented in that the software 1610 and 1640 causes messages to be transmitted, in particular empty or ‘dummy’ messages, using the OTT connection 1616 while it monitors propagation times, errors, etc.

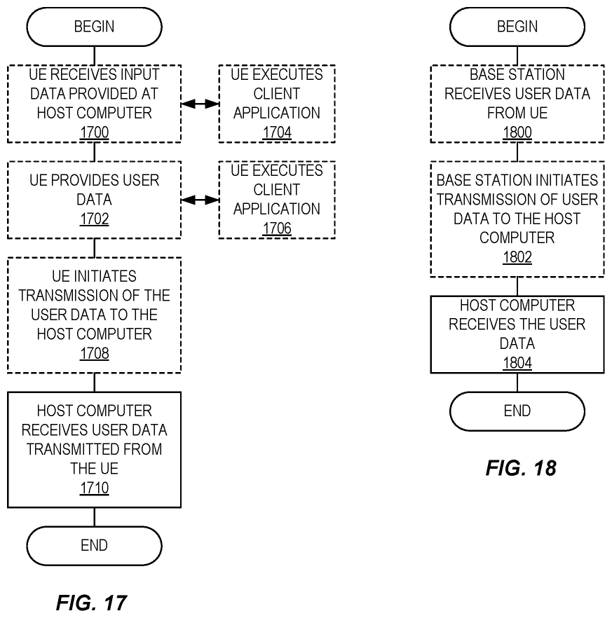

FIG. 17 is a flowchart illustrating a method implemented in a communication system, in accordance with one embodiment. The communication system includes a host computer, a base station, and a UE which may be those described with reference to FIGS. 15 and 16. For simplicity of the present disclosure, only drawing references to FIG. 17 will be included in this section. In step 1700 (which may be optional), the UE receives input data provided by the host computer. Additionally or alternatively, in step 1702, the UE provides user data. In sub-step 1704 (which may be optional) of step 1700, the UE provides the user data by executing a client application. In sub-step 1706 (which may be optional) of step 1702, the UE executes a client application which provides the user data in reaction to the received input data provided by the host computer. In providing the user data, the executed client application may further consider user input received from the user. Regardless of the specific manner in which the user data was provided, the UE initiates, in sub-step 1708 (which may be optional), transmission of the user data to the host computer. In step 1710 of the method, the host computer receives the user data transmitted from the UE, in accordance with the teachings of the embodiments described throughout this disclosure.

FIG. 18 is a flowchart illustrating a method implemented in a communication system, in accordance with one embodiment. The communication system includes a host computer, a base station, and a UE which may be those described with reference to FIGS. 15 and 16. For simplicity of the present disclosure, only drawing references to FIG. 18 will be included in this section. In step 1800 (which may be optional), in accordance with the teachings of the embodiments described throughout this disclosure, the base station receives user data from the UE. In step 1802 (which may be optional), the base station initiates transmission of the received user data to the host computer. In step 1804 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

### Group A Embodiments

Embodiment 1: A method performed by a wireless communication device for uplink transmission to a cellular communications network, the method comprising: transmitting (808) one or more Physical Uplink Shared Channels, PUSCHs, to two or more Transmission and Reception Points, TRPs, of a cellular communications network on a same time and frequency domain resource or on a same time domain resource but different frequency domain resources; wherein the two or more TRPs are associated with two or more different reference signals, respectively.

Embodiment 2: The method of embodiment 1 further comprising receiving (806), from a network node (e.g., one of the two or more TRPs), downlink control information that schedules transmission of the one or more PUSCHs.

Embodiment 3: The method of embodiments 1 and 2 wherein the downlink control information indicates the two or more reference signals.

Embodiment 4: The method of embodiments 1 to 3 wherein the two or more reference signals are two or more downlink reference signals each associated with a respective TCI state.

Embodiment 4a: The method of embodiment 4 wherein each of the two or more downlink reference signal is an SSB or a NZP CSI-RS.

Embodiment 5: The method of embodiments 1 to 3 wherein the two or more reference signals are two or more Sounding Reference Signal, SRS, resources, each configured with a respective spatial relation.

Embodiment 6: The method of embodiment 5 wherein the downlink control information comprises one or more SRS resource indicators, SRIs, that indicate the two or more SRS resources.

Embodiment 7: The method of embodiment 6 wherein each of the two or more SRS resources is associated with a respective reference signal through a spatial relation configuration.

Embodiment 8: The method of embodiment 7 wherein the respective reference signal is an SSB, a NZP CSI-RS, or another SRS.

Embodiment 9: The method of embodiment 6 wherein: the two or more SRS resources are associated with two or more respective reference signals; and the two or more respective reference signals are associated with two or more respective cell IDs (i.e., each respective reference signal is associated with a different cell ID).

Embodiment 10: The method of embodiment 9 wherein the two or more respective reference signals are two or more respective SSBs or two or more respective NZP CSI-RSs.

Embodiment 11: The method of embodiment 9 or 10 wherein the two or more respective reference signals are associated with the two or more respective cell IDs via a field in a TCI state configuration.

Embodiment 12: The method of embodiment 9 wherein the two or more respective reference signals are two or more respective SSBs, and the two or more reference signals are associated with the two or more respective cell IDs via SSB configuration.

Embodiment 13: The method of any one of embodiments 1 to 12 further comprising receiving (806) an indication of a pathloss reference signal and a set of power control parameters for each of the one or more PUSCHs via the one or more SRI or the one or more TCI state, wherein association between an SRI or a TCI state and one or more pathloss reference signals and one or more sets of power control parameters is signaled to the wireless communication device.

Embodiment 14: The method of any one of embodiments 6 to 12 further comprising: receiving (802) information that defines, for each SRI of a set of SRIs comprising the one or more SRIs or each TCI state of a set of TCI states comprising the one or more TCI state, an association between the SRI or the TCI state and one or more pathloss reference signals and one or more sets of power control parameters; and receiving (806) an indication of a pathloss reference signal and a set of power control parameters for each of the one or more PUSCHs via the one or more SRI or the one or more TCI state.

Embodiment 15: The method of embodiment 13 or 14 wherein transmitting (808) the one or more PUSCHs to the two or more TRPs comprises transmitting (808) the one or more PUSCHs to the two or more TRPs in accordance the indicated set of power control parameters for each of the one or more PUSCHs.

Embodiment 16: The method of any one of embodiments 5 to 15 wherein the two or more SRS resources belong to either a same SRS resource set or different SRS resource sets.

Embodiment 17: The method of any one of embodiments 1 to 16 further comprising receiving (804), from a network node (e.g., one of the two or more TRPs), an indication to use either a spatial division multiplexing scheme for multi-TRP PUSCH transmission or a frequency division multiplexing scheme for multi-TRP PUSCH transmission.

Embodiment 18: The method of embodiment 17 wherein transmitting (808) the one or more PUSCHs to the two or more TRPs comprises transmitting (808) the one or more PUSCHs to the two or more TRPs on the same time and frequency domain resource if the received indication is an indication to use the spatial division multiplexing scheme for multi-TRP PUSCH transmission or on the same time domain resource but different frequency domain resources if the received indication is an indication to use the frequency division multiplexing scheme for multi-TRP PUSCH transmission.

Embodiment 19: The method of embodiment 1 wherein the one or more PUSCHs comprise two or more PUSCHs, and each PUSCH of the two or more PUSCHs is scheduled via a separate downlink control information.

Embodiment 20: The method of any one of embodiments 1 to 19 wherein the two or more TRPs are indicated in the downlink control information through indication of two or more TCI states, or two or more SRS resources, wherein each TRP is associated with one TCI state or one SRS resource.

Embodiment 21: The method of any of the previous embodiments, further comprising: providing user data; and forwarding the user data to a host computer via the transmission of the one or more PUSCHs to the two or more TRPs.

### Group B Embodiments

Embodiment 22: A method performed by a Transmission and Reception Point, TRP, for a cellular communications network, the method comprising: Receiving (808-1) a first part of a multi-TRP Physical Uplink Shared Channel, PUSCH, from a wireless communication device, the multi-TRP PUSCH transmission comprising one or more PUSCHs to two or more TRPs of a cellular communications network on a same time and frequency domain resource or on a same time domain resource but different frequency domain resources; wherein the two or more TRPs are associated with two or more different reference signals, respectively.

Embodiment 23: The method of embodiment 22 further comprising transmitting (806), to the wireless communication device, downlink control information that schedules transmission of the one or more PUSCHs.

Embodiment 24: The method of embodiments 22 and 23 wherein the downlink control information indicates the two or more reference signals.

Embodiment 25: The method of embodiments 22 to 24 wherein the two or more reference signals are two or more downlink reference signals each associated with a respective TCI state.

Embodiment 26: The method of embodiments 22 to 24 wherein the two or more reference signals are two or more Sounding Reference Signal, SRS, resources, each configured with a respective spatial relation.

Embodiment 27: The method of embodiment 26 wherein the downlink control information comprises one or more SRS resource indicators, SRIs, that indicate the two or more SRS resources.

Embodiment 28: The method of embodiment 27 wherein each of the two or more SRS resources is associated with a respective reference signal through a spatial relation configuration.

Embodiment 29: The method of embodiment 28 wherein the respective reference signal is an SSB, a NZP CSI-RS, or another SRS.

Embodiment 30: The method of embodiment 27 wherein: the two or more SRS resources are associated with two or more respective reference signals; and the two or more respective reference signals are associated with two or more respective cell IDs (i.e., each respective reference signal is associated with a different cell ID).

Embodiment 31: The method of embodiment 30 wherein the two or more respective reference signals are two or more respective SSBs or two or more respective NZP CSI-RSs.

Embodiment 32: The method of embodiment 30 or 31 wherein the two or more respective reference signals are associated with the two or more respective cell IDs via a field in a TCI state configuration.

Embodiment 33: The method of embodiment 30 wherein the two or more respective reference signals are two or more respective SSBs, and the two or more reference signals are associated with the two or more respective cell IDs via SSB configuration.

Embodiment 34: The method of any one of embodiments 27 to 33 further comprising transmitting (806), to the wireless communication device, an indication of a pathloss reference signal and a set of power control parameters for each of the one or more PUSCHs via the one or more SRI, or one or more TCI state, wherein association between an SRI or a TCI state and one or more pathloss reference signals and one or more sets of power control parameters is signaled to the wireless communication device.

Embodiment 35: The method of any one of embodiments 27 to 33 further comprising: transmitting (802), to the wireless communication device, information that defines, for each SRI of a set of SRIs comprising the one or more SRIs or for each TCI state of a set of TCI states comprising the one or more TCI state, an association between the SRI or the TCI state and one or more pathloss reference signals and one or more sets of power control parameters; and transmitting (806), to the wireless communication device, an indication of a pathloss reference signal and a set of power control parameters for each of the one or more PUSCHs via the one or more SRI, or one or more TCI state.

Embodiment 36: The method of any one of embodiments 26 to 35 wherein the two or more SRS resources belong to either a same SRS resource set or different SRS resource sets.

Embodiment 37: The method of any one of embodiments 22 to 36 further comprising transmitting (804), to the wireless communication device, an indication to use either a spatial division multiplexing scheme for multi-TRP PUSCH transmission or a frequency division multiplexing scheme for multi-TRP PUSCH transmission.

Embodiment 38: The method of embodiment 22 wherein the one or more PUSCHs comprise two or more PUSCHs, and each PUSCH of the two or more PUSCHs is scheduled via a separate downlink control information.

Embodiment 39: The method of any one of embodiments 22 to 38 wherein the two or more TRPs are indicated in the downlink control information through indication of two or more TCI states, or two or more SRS resources, wherein each TRP is associated with one TCI state or one TCI state.

Embodiment 40: The method of any of the previous embodiments, further comprising: receiving user data from the wireless communication device via the first part of the multi-TRP PUSCH transmission; and forwarding the user data to a host computer.

### Group C Embodiments

Embodiment 41: A wireless communication device comprising: processing circuitry configured to perform any of the steps of any of the Group A embodiments; and power supply circuitry configured to supply power to the wireless communication device.

Embodiment 42: A TRP comprising: processing circuitry configured to perform any of the steps of any of the Group B embodiments; and power supply circuitry configured to supply power to the TRP.

Embodiment 43: A User Equipment, UE, comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 44: A communication system including a host computer comprising: communication interface configured to receive user data originating from a multi-TRP PUSCH transmission from a User Equipment, UE, to two or more TRPs; wherein the UE comprises a radio interface and processing circuitry, the UE's processing circuitry configured to perform any of the steps of any of the Group A embodiments.

Embodiment 45: The communication system of the previous embodiment, further including the UE.

Embodiment 46: The communication system of the previous 2 embodiments, further including the two or more TRPs, wherein each of the two or more TRPs comprises a radio interface configured to communicate with the UE and a communication interface configured to forward to the host computer the user data carried by a respective part of the multi-TRP PUSCH transmission from the UE to the TRP.

Embodiment 47: The communication system of the previous 3 embodiments, wherein: the processing circuitry of the host computer is configured to execute a host application; and the UE's processing circuitry is configured to execute a client application associated with the host application, thereby providing the user data.

Embodiment 48: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Embodiment 49: A method implemented in a communication system including a host computer, two or more TRPs, and a User Equipment, UE, the method comprising: at the host computer, receiving user data transmitted to the two or more TRPs from the UE, wherein the UE performs any of the steps of any of the Group A embodiments.

Embodiment 50: The method of the previous embodiment, further comprising, at the UE, providing the user data to the two or more TRPs.

Embodiment 51: The method of the previous 2 embodiments, further comprising: at the UE, executing a client application, thereby providing the user data to be transmitted; and at the host computer, executing a host application associated with the client application.

Embodiment 52: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data.

Embodiment 53: A communication system including a host computer comprising a communication interface configured to receive user data originating from a multi-TRP PUSCH transmission from a User Equipment, UE, to two or more TRPs, wherein each of the two or more TRPs comprises a radio interface and processing circuitry, the TRP's processing circuitry configured to perform any of the steps of any of the Group B embodiments.

Embodiment 54: The communication system of the previous embodiment further including the TRP.

Embodiment 55: The communication system of the previous 2 embodiments, further including the UE, wherein the UE is configured to communicate with the two or more TRPs.

Embodiment 56: The communication system of the previous 3 embodiments, wherein: the processing circuitry of the host computer is configured to execute a host application; and the UE is configured to execute a client application associated with the host application, thereby providing the user data to be received by the host computer.

Embodiment 57: A method implemented in a communication system including a host computer, two or more TRPs, and a User Equipment, UE, the method comprising: at the host computer, receiving, from the two or more TRPs, user data originating from a multi-TRP PUSCH transmission which the two or more TRPs have received from the UE, wherein the UE performs any of the steps of any of the Group A embodiments.

Embodiment 58: The method of the previous embodiment, further comprising at the two or more TRPs, receiving the user data from the UE.

Embodiment 59: The method of the previous 2 embodiments, further comprising at the two or more TRPs, initiating a transmission of the received user data to the host computer.

Those skilled in the art will recognize improvements and modifications to the embodiments of the present disclosure. All such improvements and modifications are considered within the scope of the concepts disclosed herein.

1. A method performed by a wireless communication device, the method comprising:
receiving, from a network node, a configuration of two Sounding Reference Signal, SRS, resource sets, a first and second SRS resource sets, each comprising one or more downlink SRS resources, wherein the first and second SRS resource sets are associated with a first and second transmission and reception points, TRPs, respectively;
receiving, from the network node, downlink control information, DCI, that schedules a first physical uplink channel transmission associated to a first SRS resource in the first SRS resource set and a second physical uplink channel transmission associated to a second SRS resource in the second SRS resource set, wherein the first and second SRS resources are indicated in the DCI; and
transmitting the first and second physical uplink channel transmissions in accordance with the DCI, wherein the first and the second physical uplink channel transmissions are transmitted towards to the first and second TRPs, respectively, in a same symbol(s) in time simultaneously, wherein the first and the second physical uplink channel transmissions are one of:
(a) a first and second layers of a same physical uplink channel,
(b) a first and second parts of a same physical uplink channel, wherein the first apart is transmitted in a first frequency domain resource and the second part is transmitted in a second frequency domain resource,
(c) a first and second physical uplink channels, wherein the first channel is transmitted in a first frequency domain resource and the second channel is transmitted in a second frequency domain resource,
(d) a first and second physical uplink channels associated to a same data transport block, wherein the first channel encoded with a first redundancy version and the second channel is encoded with a second redundancy version.

2. The method of claim 1 wherein the first and second SRS resources are indicated in a first and a second SRS Resource Indicator, SRI, fields in the DCI, respectively.

3. The method of claim 2 wherein the first and second SRI fields are associated with the first and second SRS resource sets, respectively.

4. The method of claim 1 further comprises receiving a configuration of first and second sets of power control parameters associated with the first and second SRS resources, respectively, wherein each of the first and second sets of power control parameters comprise a pathloss reference signal, a fractional power control factor, a target receive power, a closed-loop power control index, or any combination thereof.

5. The method of claim 4 wherein the first and second physical uplink channel transmissions are transmitted with a first and second transmit powers, respectively, wherein the first and second transmit powers are calculated based on the first and second sets of power control parameters, respectively.

6. The method of claim 1 wherein the first and second physical uplink channel transmissions are physical uplink shared channel, PUSCH, transmissions.

7. The method of claim 2 wherein a set of possible codepoints for each of the first and second SRI fields in the DCI comprises a codepoint to indicate that a corresponding SRS resource is not selected.

8. The method of claim 1 wherein the DCI further indicates a first and second Transmit Power Control, TPC, commands for the first and second physical uplink channel transmissions, respectively.

9. The method of claim 1 wherein the first and second physical uplink channel transmissions are first and second parts of a same physical uplink channel, wherein the first apart is transmitted in a first frequency domain resource and the second part is transmitted in a second frequency domain resource.

10. The method of claim 1 wherein the first and second parts of the physical uplink channel transmissions are a first and second physical uplink channels associated to a same data transport block, wherein the first channel encoded with a first redundancy version and the second channel is encoded with a second redundancy version.

11. The method of claim 1 wherein the first and second parts of the physical uplink channel transmissions are a first and second layers of a same physical uplink channel.

12. The method of claim 1 wherein the first and second SRS resources indicated in the DCI may be replaced with a first and second uplink Transmission Configuration Indicator, TCI, states, wherein each of the first and second TCI states comprises a reference signal index for spatial relation indication, a pathloss reference signal index, a set of power control parameters, or any combination thereof.

13. (canceled)

14. (canceled)

15. A wireless communication device comprising:
one or more transmitters;
one or more receivers; and
processing circuitry associated with the one or more transmitters and the one or more receivers, the processing circuitry configured to cause the wireless communication device to:
receive, from a network node, a configuration of two Sounding Reference Signal, SRS, resource sets, a first and second resource sets, each comprising one or more downlink SRS resources wherein the first and second SRS resource sets are associated with a first and second transmission and reception points, TRPs, respectively;
receive, from the network node, downlink control information, DCI, that schedules a first physical uplink channel transmission comprising a first part associated to a first SRS resource in the first SRS resource set and a second part physical uplink channel transmission associated to a second SRS resource in the second SRS resource set, wherein the first and second SRS resources are indicated in the DCI; and
transmit the first and second physical uplink channel transmissions in accordance with the DCI, wherein the first part and the second physical uplink channel transmissions are transmitted towards to the first TRP and the second TRP, respectively, in a same symbol(s) in time simultaneously,
wherein the first and the second physical uplink channel transmissions are one of:
(a) a first and second layers of a same physical uplink channel,
(b) a first and second parts of a same physical uplink channel, wherein the first apart is transmitted in a first frequency domain resource and the second part is transmitted in a second frequency domain resource,
(c) a first and second physical uplink channels, wherein the first channel is transmitted in a first frequency domain resource and the second channel is transmitted in a second frequency domain resource,
(d) a first and second physical uplink channels associated to a same data transport block, wherein the first channel encoded with a first redundancy version and the second channel is encoded with a second redundancy version.

16-26. (canceled)

27. A method performed by a network node, the method comprising:
sending, to a wireless communication device, a configuration of two Sounding Reference Signal, SRS, resource sets, a first and second SRS resource sets, each comprising one or more downlink SRS resources, wherein the first and second SRS resource sets are associated with a first and second transmission and reception points, TRPs, respectively; and
sending, to the wireless communication device, downlink control information, DCI, that schedules a first physical uplink channel transmission associated to a first SRS resource in the first SRS resource set and a second physical uplink channel transmission associated to a second SRS resource in the second SRS resource set, wherein the first and second SRS resources are indicated in the DCI and the first and the second physical uplink channel transmissions are one of:
(a) a first and second layers of a same physical uplink channel,
(b) a first and second parts of a same physical uplink channel, wherein the first apart is transmitted in a first frequency domain resource and the second part is transmitted in a second frequency domain resource,
(c) a first and second physical uplink channels, wherein the first channel is transmitted in a first frequency domain resource and the second channel is transmitted in a second frequency domain resource,
(d) a first and second physical uplink channels associated to a same data transport block, wherein the first channel encoded with a first redundancy version and the second channel is encoded with a second redundancy version.

28. The method of claim 27 wherein the first and second SRS resources are indicated in a first and a second SRS Resource Indicator, SRI, fields in the DCI, respectively.

29. The method of claim 28 wherein the first and second SRI fields are associated with the first and second SRS resource sets, respectively.

30. The method of claim 27 further comprising sending, to the wireless communication device, a configuration of a first and a second sets of power control parameters associated with the first and second SRS resources, respectively, wherein the power control parameters comprise a pathloss reference signal, a fractional power control factor, a target receive power, a closed-loop power control index, or any combination thereof.

31. The method of claim 30 wherein, the first and second physical uplink channel transmissions are transmitted with a first and second transmit powers, respectively, wherein the first and second transmit powers are calculated based on the first and second sets of power control parameters, respectively.

32. The method of claim 27 wherein the first and second physical uplink channel transmissions are physical uplink shared channel, PUSCH, transmissions.

33. The method of claim 28 wherein a set of possible codepoints for each of the first and second SRI fields in the DCI comprises a codepoint to indicate that a corresponding SRS resource is not selected.

34. The method of claim 27 wherein the DCI further indicates a first and second Transmit Power Control, TPC, commands for the first and second physical uplink channel transmissions, respectively.

35. The method of claim 27 wherein the first and second physical uplink channel transmissions are a first and second parts of a same physical uplink channel, wherein the first apart is transmitted in a first frequency domain resource and the second part is transmitted in a second frequency domain resource.

36. The method of claim 27 wherein the first and second physical uplink channel transmissions are a first and second physical uplink channels associated to a same data transport block, wherein the first channel encoded with a first redundancy version and the second channel is encoded with a second redundancy version.

37. The method of claim 27 wherein the first and second physical uplink channel transmissions are a first and second layers of a same physical uplink channel.

38. The method of claim 27 wherein the first and second SRS resources indicated in the DCI may be replaced with a first and second uplink Transmission Configuration Indicator, TCI, states, wherein each of the first and second TCI states comprises a reference signal index for spatial relation indication, a pathloss reference signal index, a set of power control parameters, or any combination thereof.

39. (canceled)

40. (canceled)

41. A network node comprising processing circuitry configured to cause the network node to:
send, to a wireless communication device, a configuration of two Sounding Reference Signal, SRS, resource sets, a first and second SRS resource sets, each comprising one or more downlink SRS resources, wherein the first and second SRS resource sets are associated with a first and second transmission and reception points, TRPs, respectively; and
send, to the wireless communication device, downlink control information, DCI, that schedules a first physical uplink channel transmission associated to a first SRS resource in the first SRS resource set and a second physical uplink channel transmission associated to a second SRS resource in the second SRS resource set, wherein the first and second SRS resources are indicated in the DCI and the first and the second physical uplink channel transmissions are one of:
(a) a first and second layers of a same physical uplink channel,
(b) a first and second parts of a same physical uplink channel, wherein the first apart is transmitted in a first frequency domain resource and the second part is transmitted in a second frequency domain resource,
(c) a first and second physical uplink channels, wherein the first channel is transmitted in a first frequency domain resource and the second channel is transmitted in a second frequency domain resource,
(d) a first and second physical uplink channels associated to a same data transport block, wherein the first channel encoded with a first redundancy version and the second channel is encoded with a second redundancy version.

42-59. (canceled)
